(19) United States
(12) Patent Application Publication
(10) Pub. No.: US 2021/0239224 A1
(43) Pub. Date: Aug. 5, 2021

(54) FLOW CONTROL VALVE AND HYDRONIC SYSTEM

(71) Applicant: CGC GROUP OF COMPANIES INCORPORATED, Mississauga (CA)

(72) Inventors: Robert G. RUTHERFORD, Mississauga (CA); William J. BROWNE, Newmarket (CA)

(21) Appl. No.: 16/649,535

(22) PCT Filed: Sep. 14, 2018
(86) PCT No.: PCT/IB2018/057075

§ 371 Date: Mar. 20, 2020

Related U.S. Application Data
(60) Provisional application No. 62/561,641, filed on Sep. 21, 2017.

(51) Int. Cl. F16K 11/085; F24F 11/84

(52) U.S. Cl. CPC F16K 11/0853; F24F 11/84

(57) ABSTRACT

A flow control valve has a body defining a cavity therein, a first and second outlets, a first and second inlets, and a modulating body disposed at least in part in the cavity. The modulating body is pivotable in: a) a first range of angular positions, in which the modulating body fluidly connects the first outlet to the first inlet and blocks the second opening and the fourth opening; b) a second range of angular positions, in which the modulating body fluidly connects the second outlet to the second inlet and blocks the first and the third opening; c) a third range of angular positions, in which modulating body fluidly connects the first outlet and the second outlet to the second inlet and blocks the third opening; and d) a fourth position, in which the modulating body blocks the third opening and the fourth opening.

### CROSS-REFERENCE

The present application claims priority to U.S. Provisional Patent Application No. 62/561,641 filed Sep. 21, 2017, entitled “Flow Control Valve and Hydronic System”, which application is incorporated herein by reference in its entirety.

### TECHNICAL FIELD

The implementations disclosed herein relate to fluid control valves and hydronic systems.

### BACKGROUND

Numerous valves, such as 2-way and 3-way flow control valves, are known. Such valves are often used to control fluid flow in various hydronic systems, such as heating, ventilating, air conditioning and refrigeration (“HVAC&R”) systems. An example of a hydronic system is a water source heat pump system that may be implemented in a building to individually condition spaces, such as offices or condominium units, in the building. A heat pump system may use a single fluid loop to transfer heat to and from the heat pumps that may be present in the system.

A heat pump connected to the fluid loop may either take energy from the fluid in the fluid loop and inject it into at least one space served by the heat pump, or may reject heat from the at least one space into the fluid in the loop, depending on the possible heating, cooling, and de-humidification demands of the at least one space. A standard water source heat pump system may include at least one heat pump in each space in which the climate is to be controlled by the at least one heat pump.

The fluid loop may be equipped with pumps that may circulate a fluid, such as water or a glycol solution, in the fluid loop, and thereby provide a supply of the fluid to each hydronic system, such as a heat pump, that may be connected to the fluid loop. A standard water source heat pump may use a compressor (or a plurality of compressors, depending on the configuration of that heat pump) connected with a direct expansion coil (“DX coil”) to both heat and cool the at least one space conditioned by that heat pump.

A controller of the heat pump may operate the compressor(s) in one of two possible directions to reject heat from the space(s) into the hydronic loop in response to a cooling call, and in the other of the two possible directions to extract heat from the loop and transfer it to the at least one space via the DX coil. Standard heat pumps use at least one reversing valve in order to enable this operation. A number of inefficiencies may be associated with the operation of standard water source heat pumps.

In the last two decades, the North American HVAC&R industry has received encouragement from governments to mitigate operational inefficiencies of hydronic systems in order to reduce the impact of such systems on the environment. To help this cause, the CGC Group of companies has developed a hydronic system that will be further referred to as a hybrid (water source) heat pump A hybrid heat pump may include in an air stream a hydronic heating coil in series with a DX coil. The hybrid heat pump may provide heating to the space(s) served by that heat pump via the hydronic heating coil, instead of using the DX coil.

Using the hydronic heating coil instead of the DX coil may avoid using the refrigerant compressor(s) connected with the DX coil and may thereby avoid the electricity consumption that is associated with running the refrigerant compressor(s). Thus, a hybrid heat pump may, at least in some cases, consume less electricity than a standard heat pump that operates refrigerant compressor(s) to provide heating.

In many jurisdictions, heat generated by electricity (for example, using resistance heaters or refrigerant compressors) is more expensive than heat generated by a source like natural gas (for example, by operating natural gas boilers to heat the fluid loop). Therefore, in at least some jurisdictions and for some applications, hybrid heat pumps may provide operational cost savings associated with lower electricity consumption.

Prior hybrid heat pump systems have used fluid loops with continuous and constant fluid flow throughout the loop and through each hybrid heat pump connected to that loop. The flow was constant twenty four hours per day, three hundred and sixty five days per year, irrespective of whether each hybrid heat pump was heating, cooling, or receiving no heating or cooling call and therefore not operating (further referred to as “idle”). In a drive to improve operating efficiencies of hydronic systems, some jurisdictions in North America have implemented requirements to reduce flow rates in hydronic system fluid loops and in individual hydronic systems, such as individual heat pumps, whenever possible.

For example, some jurisdictions in North America may require hydronic systems, such as heat pump systems, to stop flow to the hydronic systems whenever those systems are not operating (i.e. idle), and to regulate flow of fluid (that is, increase or decrease the flow, depending on the demand) through those systems when those systems are operating (i.e. cooling, heating, and/or dehumidifying at least one space).

To meet these requirements for a hydronic system such as a hybrid heat pump (a hybrid heat pump may be classified as a hydronic system), at least three flow control devices have heretofore been required. A first two-way valve has been required to regulate flow of fluid from a fluid loop into a condenser of a given hybrid heat pump, a second two-way valve has been required to regulate flow of the fluid from the fluid loop into the hydronic heating coil of the given heat pump, and at least one flow sensor has been required to monitor flow. In other examples, a combination of two-way valves and three-way valves may have been used.

While existing systems are suitable for their intended purposes, a number of drawbacks and inefficiencies are associated with using three or more flow control devices to control a single hydronic system (for example, hybrid heat pump).

In one aspect, each of the first and second two-way valves may require a dedicated actuator. In another aspect, a controller may be required that is capable of receiving a connection from each of the dedicated actuators and controlling each of the dedicated actuators. In yet another aspect, manufacturing a hydronic system having the three or more flow control devices may require piping, electrical connections, and controls for each of the devices.

### SUMMARY

It is an object of the present technology to ameliorate at least some of the inconveniences present in the prior art.

For the purposes of the present document, the term “conduit” refers to a notional conduit that supplies a fluid (such as, for example, air or a liquid) from one point to at least one other point. That is, for example, a given “air conduit” that delivers air from point A to point B could be defined by a single conventionally known air duct that supplies air from the point A to the point B, a plurality of conventionally known air ducts interconnected to supply air from the point A to the point B, or a combination of one or more conventionally known air ducts and other structures arranged to supply air from the point A to the point B.

Similarly, a conduit for a liquid is notional and could be defined by a single pipe, more than one pipe, or a combination of one or more pipes and other structures interconnected to deliver the liquid as specified with respect to the conduit. Also, one or more elements defining a given conduit need not be interconnected (flow-wise) in series, and could be interconnected (flow-wise) in parallel or in a combination of series and parallel fluid flow connections.

For the purposes of the present document, the term “marginal flow” means an accepted (if any) amount of leakage through a specified element (such as an orifice, or a gap, or other flow path) when that element is in a closed position.

For the purposes of the present document, the term “supply air” means air supplied to a space for the purposes of heating, cooling or dehumidifying the space.

According to one aspect of the present technology, there is provided a flow control valve, including: a body defining: a cavity therein, the cavity having a peripheral wall positioned radially about a pivot axis, a first outlet fluidly connected to the cavity via a first opening defined in the peripheral wall of the cavity, a second outlet fluidly connected to the cavity via a second opening defined in the peripheral wall of the cavity, a first inlet fluidly connected to the cavity via a third opening defined in the peripheral wall of the cavity, and a second inlet fluidly connected to the cavity via a fourth opening defined in the peripheral wall of the cavity; and a modulating body disposed at least in part in the cavity, the modulating body being pivotable about the pivot axis, the modulating body having an outer wall and a passageway defined therethrough, the passageway and the outer wall of the modulating body being shaped such that the modulating body is pivotable about the pivot axis in: a) a first range of angular positions, in which i) the passageway fluidly connects the first outlet to the first inlet, and ii) the outer wall of the modulating body blocks the second opening and the fourth opening; b) a second range of angular positions, in which i) the passageway fluidly connects the second outlet to the second inlet, and ii) the outer wall of the modulating body blocks the first and the third opening; c) a third range of angular positions, in which i) the passageway fluidly connects the first outlet and the second outlet to the second inlet, and ii) the outer wall of the modulating body blocks the third opening; and d) a fourth position, in which the outer wall of the modulating body blocks the third opening and the fourth opening.

In some implementations, the flow control valve further includes an actuator mounted to the body of the flow control valve, the actuator being operatively connected to the modulating body to pivot the modulating body about the pivot axis: a) in the first range of angular positions, the second range of angular positions and the third range of angular positions, and b) to the fourth position.

In some implementations, the passageway and the outer wall of the modulating body are shaped such that the modulating body is pivotable within the first range of angular positions to block a part of the first opening with the outer wall of the modulating body to modulate fluid flow through the first opening.

In some implementations, the passageway and the outer wall of the modulating body are shaped such that the modulating body is pivotable within the first range of angular positions to block a part of the third opening with the outer wall of the modulating body to modulate fluid flow through the first opening.

In some implementations, the passageway and the outer wall of the modulating body are shaped such that the modulating body is pivotable within the second range of angular positions to block a part of the fourth opening with the outer wall of the modulating body to modulate fluid flow through the second opening.

In some implementations, the passageway and the outer wall of the modulating body are shaped such that the modulating body is pivotable within the second range of angular positions to block a part of the second opening with the outer wall of the modulating body to modulate fluid flow through the second opening.

In some implementations, the passageway and the outer wall of the modulating body are shaped such that the modulating body is pivotable within the third range of angular positions to block a part of the second opening with the outer wall of the modulating body to modulate fluid flow through the second opening.

In some implementations, the passageway and the outer wall of the modulating body are shaped such that the modulating body is pivotable within the third range of angular positions to block a part of the fourth opening with the outer wall of the modulating body to modulate fluid flow through the second opening.

In some implementations: a) the modulating body is generally cylindrical; b) the outer wall of the modulating body is a sidewall of the modulating body, the sidewall being parallel to the pivot axis; c) the peripheral wall of the cavity defines a cylindrical shape; d) the pivot axis passes through a centre of the modulating body and through a centre of the cylindrical shape of the peripheral wall; and e) the sidewall of the cylinder and the peripheral wall of the cavity are shaped such that there is a predetermined clearance between the sidewall of the cylinder and the peripheral wall of the cavity.

In some implementations, the predetermined clearance is in a range of 0.001 to 1.000 millimeters.

According to another aspect of the present technology, there is provided a hydronic system that includes the flow control valve. In some implementations, the hydronic system has: a) a fan operable to create an airstream; b) a refrigeration circuit, the refrigerant circuit including: i) a condenser having a condenser fluid inlet conduit and a condenser fluid outlet conduit, the condenser fluid outlet conduit being fluidly connected to the second inlet of the flow control valve, ii) a compressor, iii) an expansion valve, and iv) a direct expansion coil, the direct expansion coil being connected to the fan via an air conduit such that the airstream passes through the direct expansion coil, the condenser, the compressor, the expansion valve, and the direct expansion coil being interconnected via a refrigerant conduit such that when the refrigerant circuit is charged with a predetermined quantity of refrigerant, the refrigerant circuit is operable to cool the direct expansion coil to cool the airstream; c) a hydronic heating coil, the hydronic heating coil: i) having a hydronic heating coil inlet conduit and a hydronic heating coil outlet conduit, the hydronic heating coil inlet conduit being fluidly connected to the first outlet of the flow control valve, and ii) being connected to the fan via the air conduit downstream of the direct expansion coil such that the airstream passes through the hydronic heating coil after passing through the direct expansion coil, and iii) being operable to heat the airstream passing through the hydronic heating coil; d) a hydronic heating coil bypass conduit fluidly connecting the second outlet of the flow control valve to the hydronic heating coil outlet conduit; and e) a condenser bypass conduit fluidly connecting the condenser fluid inlet conduit to the first inlet of the flow control valve.

In some implementations, the fan is one of: a) downstream of the hydronic heating coil in the air conduit; b) in between the direct expansion coil and the hydronic heating coil in the air conduit; and c) upstream of the direct expansion coil in the air conduit.

In some implementations, the hydronic system further includes: a) a modulating assembly, the modulating assembly including the modulating body of the flow control valve, a motor and a gear train, the gear train operatively connecting the motor to the modulating body to pivot the modulating body about the pivot axis; b) a flow sensor, the flow sensor being: i) fluidly connected to the first inlet of the flow control valve and the condenser fluid inlet conduit fluidly upstream of the first inlet of the flow control valve and the condenser fluid inlet conduit, and ii) operable to generate a flowrate signal representative of a sum of fluid flowrates through the first inlet of the flow control valve and the condenser fluid inlet conduit; c) an air temperature sensor, the air temperature sensor being: i) positioned at least in part in the air conduit downstream of the hydronic heating coil, and ii) operable to generate an air temperature signal representative of a temperature of the airstream downstream of the hydronic heating coil; and d) a controller, the controller being: i) in electronic communication with the motor of the modulating assembly, the flow sensor and the air temperature sensor, and ii) operable to actuate the motor of the modulating assembly in response to the flowrate signal and the air temperature signal to pivot the modulating body in the first range of angular positions, the second range of angular positions and the third range of angular positions, and to the fourth position.

In some implementations, the hydronic system further includes a thermostat, the thermostat being operable to generate a heating call signal, a cooling call signal and a dehumidification call signal, the controller being in electronic communication with the thermostat and being operable to actuate the motor to pivot the modulating body: a) in the first range of angular positions in response to receiving the heating call signal from the thermostat; b) in the second range of angular positions in response to receiving the cooling call signal from the thermostat; c) in the third range of angular positions in response to receiving the dehumidification signal from the thermostat; and d) to the fourth position in response to receiving no signal from the thermostat.

In some implementations, a) the thermostat is operable to generate: i) a combination of the heating call signal and the dehumidification call signal, and ii) a combination of the cooling call signal and the dehumidification call signal; and b) the controller is operable to actuate the motor to pivot the modulating body: I) in the third range of angular positions in response to the combination of the heating call signal and the dehumidification call signal, and II) in the second range of angular positions in response to the combination of the cooling call signal and the dehumidification call signal.

According to yet another aspect of the present technology, there is provided a flow control valve, that includes: a) a body defining: a cavity therein, a first outlet in fluid communication with the cavity, a second outlet in fluid communication with the cavity, a first inlet in fluid communication with the cavity, and a second inlet in fluid communication with the cavity; and b) modulating means being disposed at least in part in the cavity and being operable in: i) a first mode, in which the modulating means fluidly connects the first outlet to the first inlet and maintains the second outlet and the second inlet in a closed position, the closed position of the second outlet providing one of: no flow, and marginal flow of fluid through the second outlet, the closed position of the second inlet providing one of: no flow, and marginal flow of fluid through the second inlet; ii) a second mode, in which the modulating means fluidly connects the second outlet to the second inlet and maintains the first outlet and the first inlet in a closed position, the closed position of the first outlet providing one of: no flow, and marginal flow of fluid through the first outlet, the closed position of the first inlet providing one of: no flow, and marginal flow of fluid through the first inlet; c) a third mode, in which the modulating means fluidly connects the first outlet and the second outlet to the second inlet and maintains the first inlet in the closed position; and d) a fourth mode, in which the modulating means maintains the first inlet and the second inlet in the closed position.

In some implementations, the modulating means is operable in a fifth mode, in which the modulating means fluidly connects the first outlet to the second inlet and maintains the first inlet and the second outlet in the closed position.

In some implementations, the modulating means is operable to modulate fluid flow through the first outlet when the modulating means is in the first mode.

In some implementations, the modulating means is operable to modulate fluid flow through the first inlet when the modulating means is in the first mode.

In some implementations, the modulating means is operable to modulate fluid flow through the second outlet when the modulating means is in the second mode.

In some implementations, the modulating means is operable to modulate fluid flow through the second inlet when the modulating means is in the second mode.

In some implementations, the modulating means is operable to modulate fluid flow through the second outlet when the modulating means is in the third mode.

In some implementations, the modulating means is operable to modulate fluid flow through the second inlet when the modulating means is in the third mode.

In some implementations, the cavity has a peripheral wall positioned radially about a pivot axis, the pivot axis passing through the body of the flow control valve; the first outlet, the second outlet, the first inlet and the second inlet are defined in the peripheral wall of the cavity; the modulating means includes a modulating body, the modulating body having an outer wall and a passageway defined therethrough, the modulating body being pivotable about the pivot axis; and the outer wall of the modulating body and the passageway are shaped such that: a) when the modulating means is in the first mode, the passageway fluidly connects the first outlet to the first inlet, and the outer wall of the modulating body blocks the second outlet and the second inlet such that there is one of: no flow, and marginal flow of fluid through the second outlet and the second inlet; b) when the modulating means is in the second mode, the passageway fluidly connects the second outlet to the second inlet, and the outer wall of the modulating body blocks the first outlet and the first inlet such that there is one of: no flow, and marginal flow of fluid through the first outlet and the first inlet; c) when the modulating means is in the third mode, the passageway fluidly connects the first outlet and the second outlet to the second inlet, and the outer wall of the modulating body blocks the first inlet such that there is one of: no flow, and marginal flow of fluid through the first inlet; and d) when the modulating means is in the fourth mode, the outer wall of the modulating body blocks the first inlet and the second inlet such that there is one of: no flow, and marginal flow of fluid through the first inlet and the second inlet.

In some implementations, the first outlet is fluidly connected to the cavity via a first opening defined in the peripheral wall of the cavity; the second inlet is fluidly connected to the cavity via a second opening defined in the peripheral wall of the cavity, the second opening being different from the first opening; the passageway has a first open end defined in the outer wall of the modulating body and a second open end defined in the outer wall of the modulating body, the second open end being fluidly connected to the first open end; and the outer wall of the modulating body and the passageway are shaped such that when the modulating means is in the fifth mode, i) the first opening is fully open to the first open end of the passageway, ii) the second opening is fully open to the second open end of the passageway, and ii) the outer wall of the modulating body blocks the first inlet and the second outlet.

In some implementations, the modulating means further includes a motor mounted to the body of the flow control valve, and a gear train that operatively connects the motor to the modulating body to pivot the modulating body about the pivot axis.

According to yet another aspect of the present technology, there is provided a hydronic system that includes the flow control valve. In some implementations, the hydronic system has: a) a fan operable to create an airstream; b) a refrigerant circuit, the refrigerant circuit including: i) a condenser having a condenser fluid inlet conduit and a condenser fluid outlet conduit, the condenser fluid outlet conduit being fluidly connected to the second inlet of the flow control valve, ii) a compressor, iii) an expansion valve, and iv) a direct expansion coil, the direct expansion coil being connected to the fan via an air conduit such that the airstream passes through the direct expansion coil, the condenser, the compressor, the expansion valve, and the direct expansion coil being interconnected via a refrigerant conduit such that when the refrigerant circuit is charged with a predetermined quantity of refrigerant, the refrigerant circuit is operable to cool the direct expansion coil to cool airstream; c) a hydronic heating coil, the hydronic heating coil: i) having a hydronic heating coil inlet conduit and a hydronic heating coil outlet conduit, the hydronic heating coil inlet conduit being fluidly connected to the first outlet of the flow control valve, ii) being connected to the fan via the air conduit downstream of the direct expansion coil such that the airstream passes through the hydronic heating coil after passing through the direct expansion coil, and iii) being operable to heat the airstream passing through the hydronic heating coil; d) a hydronic heating coil bypass conduit fluidly connecting the second outlet of the flow control valve to the hydronic heating coil outlet conduit; and e) a condenser bypass conduit fluidly connecting the condenser fluid inlet conduit to the first inlet of the flow control valve.

In some implementations, the fan is one of: a) downstream of the hydronic heating coil in the air conduit; b) in between the direct expansion coil and the hydronic heating coil in the air conduit; and c) upstream of the direct expansion coil in the air conduit.

In some implementations, the hydronic system further includes: a) a flow sensor, the flow sensor being: i) fluidly connected to the first inlet of the flow control valve and the condenser fluid inlet conduit fluidly upstream of the first inlet of the flow control valve and the condenser fluid inlet conduit, and ii) operable to generate a flowrate signal representative of a sum of fluid flowrates through the first inlet of the flow control valve and the condenser fluid inlet conduit; b) an air temperature sensor, the air temperature sensor being: i) positioned at least in part in the air conduit downstream of the hydronic heating coil, and ii) operable to generate an air temperature signal representative of a temperature of the airstream downstream of the hydronic heating coil; and c) a controller, the controller being: i) in electronic communication with the motor, the flow sensor and the air temperature sensor, and ii) operable to actuate the motor in response to the flowrate signal and the air temperature signal to pivot the modulating body: I) in a first range of angular positions corresponding to the first mode, II) a second range of angular positions corresponding to the second mode, III) a third range of angular positions corresponding to the third mode, and IV) to a fourth position corresponding to the fourth mode.

In some implementations, the controller is operable to actuate the motor in response to the flowrate signal and the air temperature signal to pivot the modulating body to a full dehumidification flow position in which: a) the passageway of the modulating body fluidly connects the first outlet to the second inlet, and b) the outer wall of the modulating body blocks the first inlet and the second outlet in the closed position.

In some implementations, the hydronic system further includes a thermostat, the thermostat being operable to generate a heating call signal, a cooling call signal and a dehumidification call signal, the controller being in electronic communication with the thermostat and being operable to actuate the motor to pivot the modulating body: a) in the first range of angular positions in response to receiving the heating call signal from the thermostat; b) in the second range of angular positions in response to receiving the cooling call signal from the thermostat; c) in the third range of angular positions in response to receiving the dehumidification signal from the thermostat, and d) to the fourth position in response to receiving no signal from the thermostat.

In some implementations: a) the thermostat is operable to generate: i) a combination of the heating call signal and the dehumidification call signal, and ii) a combination of the cooling call signal and the dehumidification call signal; and b) the controller is operable to actuate the motor to pivot the modulating body: I) in the third range of angular positions in response to the combination of the heating call signal and the dehumidification call signal, and II) in the second range of angular positions in response to the combination of the cooling call signal and the dehumidification call signal.

These examples are non-limiting.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic illustration of a hydronic system according to one implementation, the hydronic system including a flow control valve according to one implementation;

FIG. 2 is a partially transparent isometric view of the valve of FIG. 1, taken from a bottom side of the valve;

FIG. 3 is a transparent isometric view of a part of the valve of FIG. 1, taken from a top side of the part of the valve;

FIG. 4 is an isometric view of the valve of FIG. 1, taken from a side of the valve;

FIG. 5 is a partially transparent isometric view of the valve of FIG. 1, taken from a top side of the valve;

FIG. 6 is an isometric view of a modulating body of the valve of FIG. 1, taken from a top side of the modulating body;

FIG. 7 is an isometric view of the modulating body of FIG. 6, taken from a bottom side of the modulating body;

FIG. 8 is a schematic illustration of a part of the hydronic system of FIG. 1, the flow control valve of the hydronic system being in a first example heating mode position;

FIG. 9 is a schematic illustration of the part of the hydronic system of FIG. 8, the flow control valve of the hydronic system being in a second example heating mode position;

FIG. 10 is a schematic illustration of the part of the hydronic system of FIG. 8, the flow control valve of the hydronic system being in a first example cooling mode position;

FIG. 11 is a schematic illustration of the part of the hydronic system of FIG. 8, the flow control valve of the hydronic system being in a second example cooling mode position;

FIG. 12 is a schematic illustration of the part of the hydronic system of FIG. 8, the flow control valve of the hydronic system being in a first example dehumidification mode position;

FIG. 13 is a schematic illustration of the part of the hydronic system of FIG. 8, the flow control valve of the hydronic system being in a second example dehumidification mode position;

and

FIG. 14 is a schematic illustration of the part of the hydronic system of FIG. 8, the flow control valve of the hydronic system being in a first example shut-off mode position.

### DETAILED DESCRIPTION

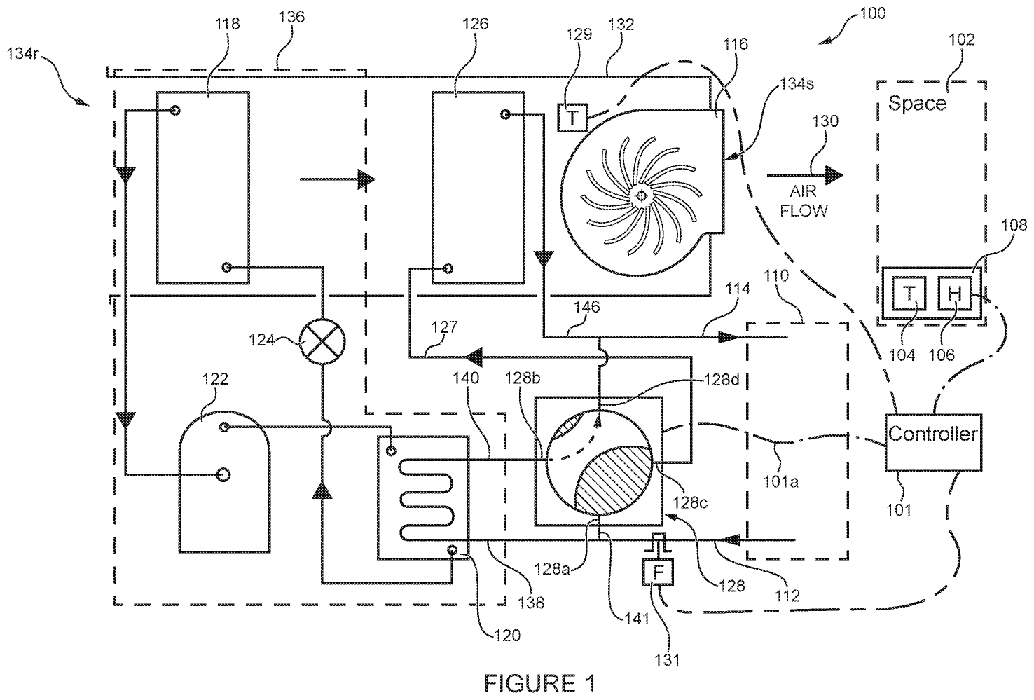

As shown in FIG. 1, the present technology is described herein with reference to a hydronic system 100 that serves (i.e. heats, cools and/or dehumidifies) a space 102 in a building (not shown). In the present implementation, the space 102 is a hotel room. The hotel room 102 is an example of a space that could be served by the hydronic system 100. The space 102 could be any other space requiring any one of or a combination of heating, cooling and dehumidification. It is contemplated that the hydronic system 100 could serve more than one space. It is contemplated that the present technology could be used with other hydronic systems. It is also contemplated that the present technology could have applications other than those described herein and that possible applications need not be limited to HVAC&R applications.

In the present implementation, the hotel room 102 includes a temperature sensor 104 and a humidistat 106 that sense the air temperature and air humidity, respectively, in the hotel room 102. In the present implementation, the temperature sensor 104 and the humidistat 106 are part of a thermostat 108. The thermostat 108 is operable to generate a cooling call signal, a heating call signal, a dehumidification call signal, a combination of a cooling call signal and a dehumidification call signal, and a combination of a heating call signal and a dehumidification call signal based on temperature and humidity signals received from the temperature sensor 104 and the humidistat 106, respectively.

The hydronic system 100 includes a controller 101 that is in electronic communication with the thermostat 108. As will be described in more detail herein below, the controller 101 operates the hydronic system 100 to heat, cool and/or dehumidify the hotel room 102 in response to signals received from the thermostat 108.

In the present implementation, heat supply to the hydronic system 100 and heat rejection from the hydronic system 100, as required depending on each operating mode of the hydronic system 100, are provided via a glycol solution supplied by and returned (after being used by the hydronic system 100) to a fluid circuit 110 installed in the building. The building is an example of a generic location where the hydronic system 100 could be used. It is contemplated that the hydronic system 100 could be used in any suitable location.

In the present implementation, the fluid circuit 110 includes a combination of pumps (not shown), boilers (not shown) and cooling towers (not shown) that heat and/or cool the glycol solution, as required depending on each operating mode of the hydronic system 100, that the fluid circuit 110 circulates through the hydronic system 100.

The fluid pumps, the boilers and the cooling towers of the fluid circuit 110 are piped in the fluid circuit 110 to inject heat into the glycol solution circulating in the fluid circuit 110 and to remove (reject) heat from the glycol solution circulating in the fluid circuit 110 as required, throughout a calendar year, depending on the particular combinations of heating and/or cooling loads that are served by the fluid circuit 110 at any given point in time. More specifically, the boilers heat the glycol solution when required, and the cooling towers cool glycol solution when required.

It is contemplated that the fluid circuit 110 could have any configuration that is suitable for each particular implementation and application of the hydronic system 100. It is contemplated that the fluid circuit 110 could serve more than a single one of the hydronic system 100 and could also simultaneously serve other systems. It is contemplated that the fluid circuit 110 could use any suitable source of heat and heat rejection, such as a geothermal system. It is contemplated that the glycol solution supplied to the hydronic system 100 could be any other suitable fluid, depending on, for example, each particular implementation and application of the hydronic system 100 and the fluid circuit 110.

Also, each particular configuration of the fluid circuit 110 could be selected using conventional engineering practices to suit each particular implementation and application of the hydronic system 100.

In the present implementation, the fluid circuit 110 supplies the glycol solution to the hydronic system 100 via a fluid supply conduit 112. In turn, and as will be described in more detail below, glycol solution returns to the fluid circuit 110 via a fluid return conduit 114. In the present implementation, these fluid conduits, and other fluid supply, return and bypass conduits described in this document are provided via conventionally known brass piping. It is contemplated that supply, return and bypass conduits could be provided by any other suitable piping, for example depending on each particular implementation and application of the hydronic system 100 and the fluid circuit 110.

The hydronic system 100 will now be described in more detail.

As shown in FIG. 1, the hydronic system 100 includes a fan 116, a direct expansion (“DX”) coil 118, a condenser 120, a refrigerant compressor 122, a refrigerant expansion valve 124, a hydronic heating coil 126, and a fluid control valve 128. The hydronic system 100 also includes a supply air temperature sensor 129 for controlling the supply air temperature provided by hydronic system 100, and a flow sensor 131 for controlling fluid flow to the hydronic system 100. Sensors and controls are described in more detail herein below.

In the present implementation, the fan 116 is an electrically powered air supply fan that is operable to supply air, as shown with arrow 130, to the hotel room 102. The size and type of the fan 116 is selected using conventionally known engineering principles to supply a suitable flowrate of air to the hotel room 102.

In the present implementation, the DX coil 118 and the hydronic heating coil 126 are connected to the fan 116 via air conduit 146. Air supplied by the fan 116 to the hotel room 102 is drawn first through a return air opening 134r defined in one end of the air conduit 146, then drawn through the DX coil 118, then drawn through the hydronic heating coil 126, then enters the fan 116 and is then supplied by the fan 116 to the hotel room 102 via a supply air opening 134s. In the present implementation, the fan 116 is positioned downstream of the hydronic heating coil 126 in the air conduit 146. It is contemplated that the fan 116 could be positioned in between the DX coil 118 and the hydronic heating coil 126. It is also contemplated that the fan 116 could be positioned upstream of the DX coil 118.

In the present implementation, the air conduit 146 is an air duct. It is contemplated that the air conduit 146 could be defined by any other suitable structure, such as a plurality of air ducts and parts of the DX coil 118 and the hydronic heating coil 126. In the present implementation, the DX coil 118, the hydronic heating coil 126 and the fan 116 are positioned inside the air conduit 146. It is contemplated that one or more of the DX coil 118, the hydronic heating coil 126 and the fan 116 could be positioned differently. For example, one, a combination of, or all of the DX coil 118, the hydronic heating coil 126 and the fan 116 could be at least in part outside of the air conduit 146.

In the present implementation, the DX coil 118 is part of a refrigeration circuit 136 that includes the condenser 120, the refrigerant compressor 122 and the refrigerant expansion valve 124. The refrigeration circuit 136, including its cooling capacity, is selected using conventionally known engineering principles to suitably cool and dehumidify air supplied to the hotel room 102 by the hydronic system 100.

The refrigeration circuit 136 is charged with a suitable predetermined amount of a refrigerant and operates with the refrigerant to cool the DX coil 118, and therefore to also cool air passing through the DX coil 118. In this implementation, the refrigerant is R-134a refrigerant. It is contemplated that a different refrigerant could be used.

When the refrigeration circuit 136 operates, the DX coil 118 cools air passing through the DX coil 118 from a first temperature at which the air enters the DX coil 118 to a second, lower, temperature at which the air exits the DX coil 118. Heat absorbed by the DX coil 118 from air passing through the DX coil 118 is rejected into the glycol solution flowing through the DX coil 118, which glycol solution is initially received by the condenser 120 via a condenser fluid inlet conduit 138 of the condenser 120. The condenser fluid inlet conduit 138 is, in turn, connected to the fluid supply conduit 112 of the fluid circuit 110 to receive glycol solution from the fluid circuit 110.

In the present implementation, the condenser fluid inlet conduit 138 (and therefore also the fluid supply conduit 112) is additionally fluidly connected to a first inlet (from condenser bypass) 128a of the fluid control valve 128 of the hydronic system 100. In the present implementation, this connection is made via a condenser bypass conduit 141. In the present implementation, the flow sensor 131 is positioned in the fluid supply conduit 112 fluidly upstream of the condenser fluid inlet conduit 138 and the condenser bypass conduit 141. Accordingly, the flow sensor 131 reads a sum of glycol solution flowrate through the condenser fluid inlet conduit 138 and glycol solution flowrate through the condenser bypass conduit 141, which is further referred to herein as “total glycol solution flow rate through the hydronic system 100”.

The condenser 120 also has a fluid outlet conduit 140 that is at one end fluidly connected to the condenser fluid inlet conduit 138 via the condenser 120 and at the other end fluidly connected to a second inlet (from condenser) 128b of the fluid control valve 128 of the hydronic system 100. Glycol solution enters the condenser fluid inlet conduit 138 from the fluid circuit 110 via the fluid supply conduit 112 at a first temperature.

Glycol solution passes through and picks up heat from the condenser 120, which heat is received at the condenser from the DX coil 118 via refrigerant in the refrigerant circuit 136 when the refrigerant compressor 122 operates, and leaves the condenser 120 via the condenser fluid outlet conduit 140 at a second temperature that is warmer than the first temperature. Glycol solution leaving the condenser 120 flows to the second inlet (from condenser) 128b of the fluid control valve 128.

As will be described in more detail herein below, the fluid control valve 128 selectively supplies glycol solution to the condenser 120 and the hydronic heating coil 126 and/or back to the fluid circuit 110. To receive glycol solution, the hydronic heating coil 126 has a hydronic heating coil inlet conduit 127 and the hydronic heating coil inlet conduit 127 is fluidly connected to a first (reheat coil) outlet 128c of the fluid control valve 128.

The hydronic heating coil 126 further has a hydronic heating coil outlet conduit 146 that is at one end fluidly connected to the hydronic heating coil inlet conduit 127 via the hydronic heating coil 126. At its other end, the hydronic heating coil outlet conduit 146 is fluidly connected to a second (reheat coil bypass) outlet 128d of the fluid control valve 128 and to the fluid return conduit 114 of the fluid circuit 110. The hydronic heating coil outlet conduit 146 returns fluid from the hydronic heating coil 126 to the fluid circuit 110 via the fluid return conduit 114.

In the present implementation, hydronic heating coil 126 is selected using conventional engineering principles to suitably heat air supplied by the hydronic system 100 to the hotel room 102. In the present implementation, the air temperature sensor 129 is positioned in the air conduit 146 downstream of the hydronic heating coil 126 and reads air temperature (further referred to herein as “supply air temperature”) of air leaving the hydronic heating coil 126 (further referred to herein as “supply air”).

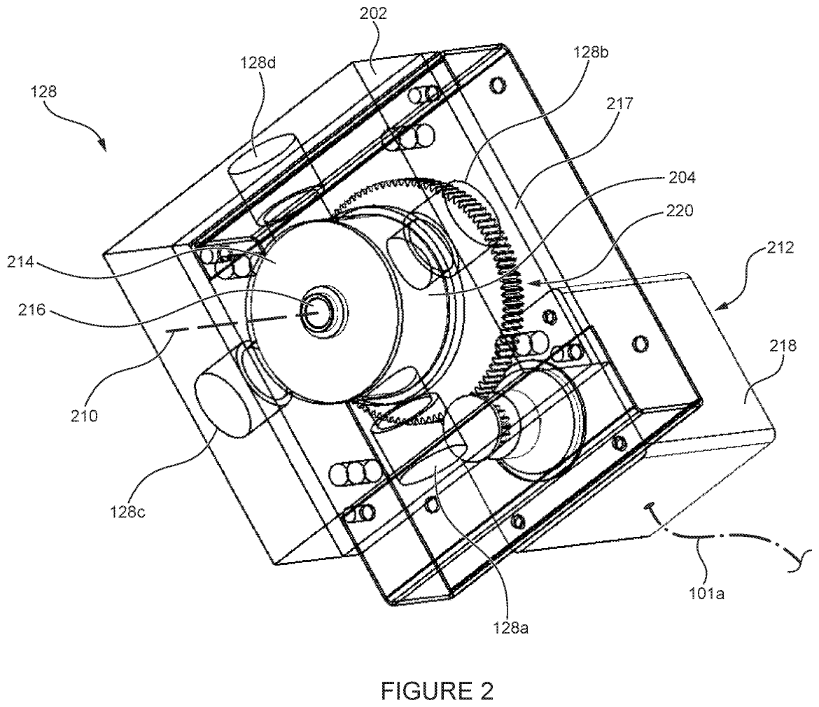

As mentioned herein above, the condenser 120 and the hydronic heating coil 126 selectively receive glycol solution via the fluid control valve 128. Referring now to FIGS. 2 to 6, the fluid control valve 128 will be described in more detail.

In the present implementation, the fluid control valve 128 has a unitary, machined, brass body 202. It is contemplated that the body 202 could be made of different materials and need not be unitary, depending on, for example, each particular application of the fluid control valve 128. The body 202 has defined therein a cavity 204, the first inlet (from condenser bypass) 128a, the second inlet (from condenser) 128b, the first (reheat coil) outlet 128c and the second (reheat coil bypass) outlet 128d.

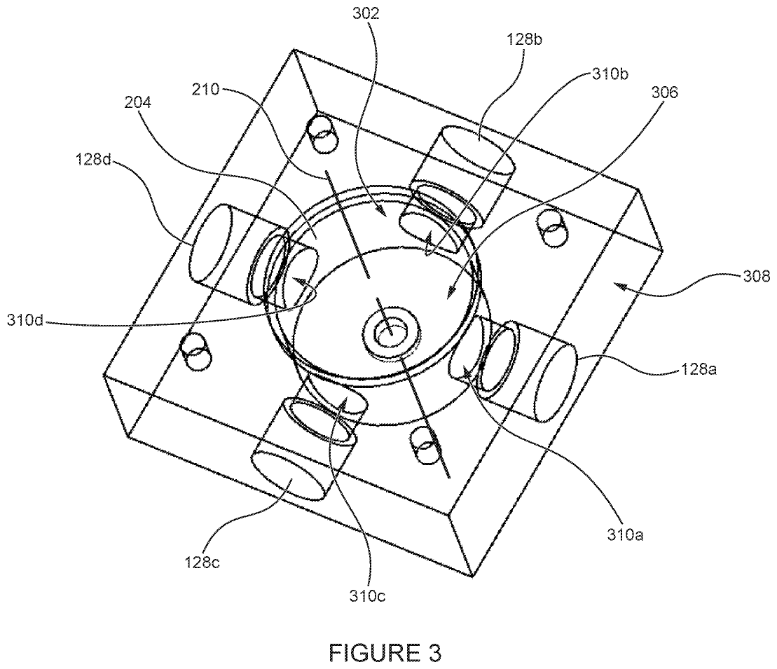

In the present implementation, and best shown in FIG. 3, the cavity 204 is defined by a peripheral wall 302. The peripheral wall 302 is positioned radially about a pivot axis 210 that passes through the body 202. In the present implementation, the pivot axis 210 is positioned orthogonal to a bottom surface 306 of the cavity 204, normal to the central axes (not shown) of the inlets and outlets 128a to 128d, and positioned such that the central axes and the pivot axis 210 all intersect at a single point. It is contemplated that the pivot axis 210 and/or the central axes could be positioned differently.

In the present implementation, the peripheral wall 302 defines a cylindrical shape. It is contemplated that in other implementations, the peripheral wall 302 could have a different shape, as will be described in more detail herein below.

In the present implementation, the first inlet (from condenser bypass) 128a, the second inlet (from condenser) 128b, the first (reheat coil) outlet 128c and the second (reheat coil bypass) outlet 128d are defined by passages machined into the body 202. The passages extend from an outer surface 308 of the body 202 into the body 202 to the peripheral wall 302 of the cavity 204. The passages terminate at corresponding openings 310a, 310b, 310c, 310d defined in the peripheral wall 302 of the cavity 204.

Referring back to FIG. 2, the fluid control valve 128 includes a modulating assembly 212. In the present implementation, the modulating assembly 212 includes a modulating body 214 that is disposed inside the cavity 204. In the present implementation, the modulating body 214 is machined from a brass cylinder and is pivotably mounted to the body 202 via a shaft 216 to pivot about the pivot axis 210. It is contemplated that the modulating body 214 could have a different shape and could be made of a different material. It is also contemplated that the modulating body 214 could be made out of a plurality of parts.

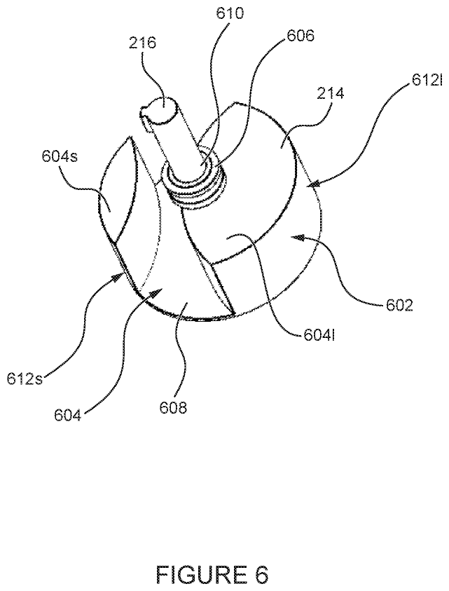

A top cap 217 is fastened to a top surface of the body 202. A seal (not shown) is disposed between the top surface of the body 202 and the top cap 217. The top cap 217 thereby fluidly seals the top end of the cavity 204 against a top surface of the body 202. In turn, the shaft 216 of the modulating body 214 extends upward through an aperture (not shown) defined in the top cap 217. A second seal 606 (FIG. 6) is positioned radially about the shaft 216 above the modulating body 214 and fluidly seals the interface between the shaft 216 and the aperture in the top cap 217.

Therefore, when the inlets and outlets 128a-128d are pressurized with a fluid, such as the glycol solution supplied to the fluid control valve 128 from the fluid circuit 110, fluid does not leak out between the top surface of the body 202 and the top cap 217 and does not leak out through the interface between the shaft 216 and the aperture in the top cap 217. It is contemplated that any other suitable fluid sealing method could be used in addition to or instead of the aforementioned seals to suitably seal the various components of the fluid control valve 128.

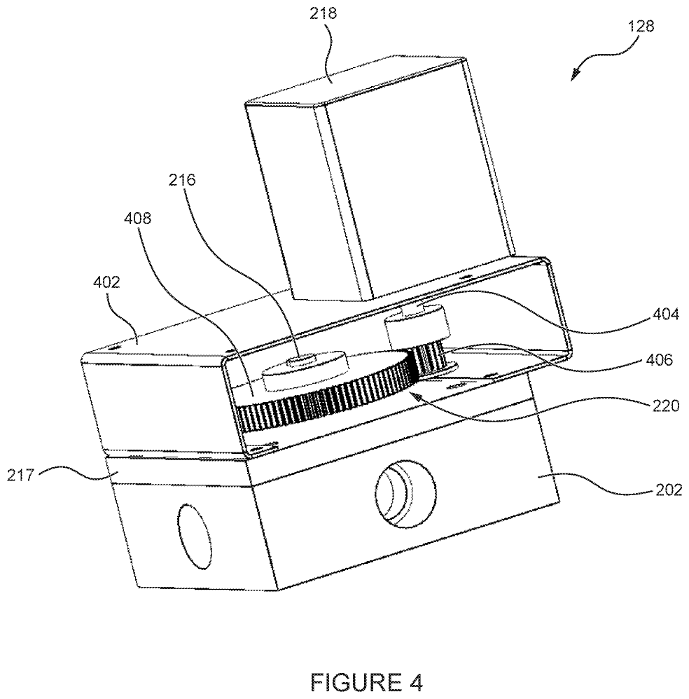

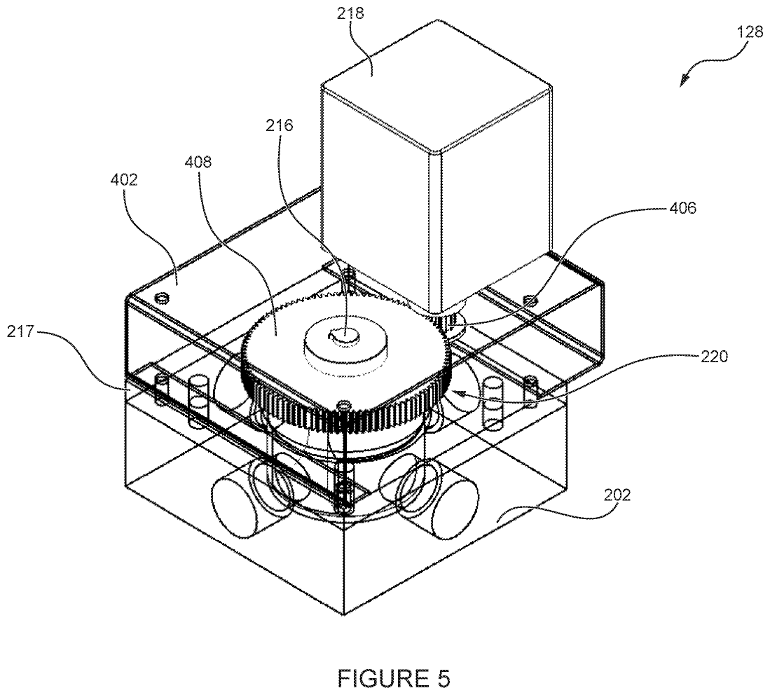

In the present implementation, the modulating assembly 212 further includes a motor 218 and a gear train 220. The motor 218 and the gear train 220 are shown in more detail in FIGS. 4 and 5. In the present implementation, the motor 218 is mounted onto a gear housing 402. In the present implementation, the gear housing 402 is a bracket open at its sides and fastened to the top cap 217 of the fluid control valve 128. The gear housing 402 protects the gear train 220 from unintentional direct physical impact. It is contemplated that the gear housing 402 could be any other suitable structure. It is also contemplated that the gear housing 402 could be omitted, in which case the motor 218 could be, for example, mounted directly onto the top cap 217 of the fluid control valve 128.

As best shown in FIG. 4, the gear train 220 operatively connects an output shaft 404 of the motor 218 to the modulating body 214 to pivot the modulating body 214 about the pivot axis 210. In the present implementation, this is achieved as follows. The gear train 220 has a smaller gear 406 and a larger gear 408. The smaller gear 406 is mounted onto the output shaft 404 of the motor 218 to be driven by the output shaft 404 of the motor 218. The larger gear 408 is mounted onto a top end of the shaft 216 of the modulating body 214 to pivot the modulating body 214. The smaller gear 406 is meshed with the larger gear 408 and drives the larger gear 408.

The ratio between the number of teeth of the smaller gear 406 and the number of teeth of the larger gear 408 (i.e. the gear ratio of the gear train 220) is selected based on the particular implementation of the motor 218, such that the motor 218 can pivot the modulating body 214 about the pivot axis 210 as described in this document. In the present implementation, the motor 218 is an electric stepper motor and the gear ratio of the gear train 220 is a 1-to-6 gear ratio. In the present implementation, the motor 218 is reversible. It is contemplated that the motor 218 could be a non-reversible motor.

The motor 218 is an example of an actuator used to pivot the modulating body 214 about the pivot axis 210. It is contemplated that a different suitable actuator could be used instead of or in addition to the motor 218. For example, a pneumatic actuator could be used. It is contemplated that the gear ratio of the gear train 220 could be a different gear ratio, selected to suit each particular actuator used to pivot the modulating body 214. It is also contemplated that the gear train 220 could have a different number of gears. The gear train 220 is an example of a transmission that operatively connects the motor 218 to the modulating body 214. It is contemplated that a different type of transmission could be used.

As shown in FIGS. 1 and 2, the motor 218 is in electronic communication with the controller 101. In this implementation, the motor 218 is in electronic communication with the controller 101 via an electronic connector 101a. The motor 218 is operable via the controller 101 to pivot the modulating body 214 about the pivot axis 210 to control flow of glycol solution to the condenser 120, the hydronic reheat coil 126 and the fluid return conduit 114 of the fluid circuit 110, as will be described in more detail herein below.

In the present implementation, the controller 101 is a Proportional-Integral controller selected and programmed to operate the fan 116, the compressor 122 and modulating assembly 212, and therefore also the modulating body 214, in response to signals received from the thermostat 108. It is contemplated that the controller 101 could be a different type of controller. For example, a Proportional-Integral-Derivative controller could be used. It is also contemplated that multiple controllers sharing functions of the controller 101 could be used instead of the controller 101.

In the present implementation, when the thermostat 108 produces a heating call signal, the controller 101 places the modulating assembly 212, and therefore also the modulating body 214, into a first mode. The first mode is referred to herein as the heating mode. When the thermostat 108 produces a cooling call signal, the controller 101 places the modulating assembly 212, and therefore also the modulating body 214, into a second mode. The second mode is referred to herein as the cooling mode. When the thermostat 108 produces a dehumidification call signal, the controller 101 places the modulating assembly 212, and therefore also the modulating body 214, into a third mode. The third mode is referred to herein as the dehumidification mode. When the thermostat 108 produces no calls (i.e. no signals), the controller 101 places the modulating assembly 212, and therefore also the modulating body 214, into a fourth mode. The fourth mode is referred to herein as the shut-off mode.

In the present implementation, each of the above-mentioned modes of operation provides for a particular fluid distribution from the fluid circuit 110 to the condenser 120 and/or the hydronic reheat coil 126, as will be described herein below. More particularly, the modulating body 214 and the cavity 304 are dimensioned and structured to provide various fluid interconnections between various ones of the inlets and outlets 128a to 128d of the fluid control valve 128 when the modulating assembly 212 is in different ones of the above-mentioned operating modes.

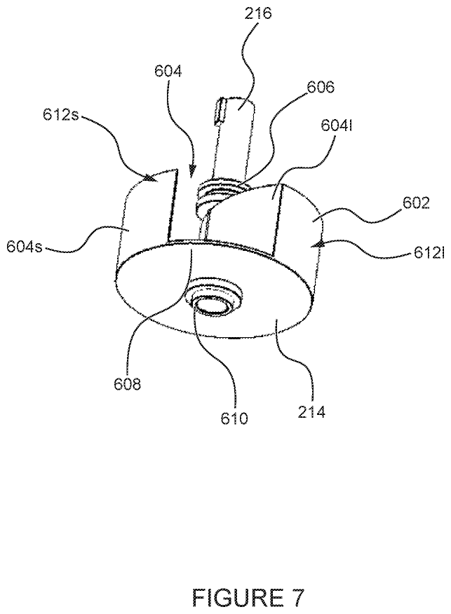

In the present implementation, and as best shown in FIGS. 6 and 7, to provide for the various interconnections between the inlets and outlets 128a to 128d, the modulating body 214 has a passageway 604 defined therethrough. The passageway 604 is defined on one side of the shaft 216 and is open at a top end of the modulating body 214. It is contemplated that the passageway 604 could be defined on both sides of the shaft 216. It is contemplated that the passageway 604 could be closed at the top end of the modulating body 214. It is also contemplated that the passageway 604 could be open at a bottom end of the modulating body 214.

An outer wall 602 of the modulating body 214 is dimensioned, relative to the peripheral wall 302 of the cavity 204, such that there is a predefined clearance between the outer wall 602 and the peripheral wall 302 of the cavity 204. In the present implementation, the predefined clearance is between 0.001 millimeters and 1.000 millimeters.

In the present implementation, the predefined clearance is defined as a range to account for possible imprecisions of machining the body 202 and the modulating body 214. It is contemplated that, at least for some particular applications, the predefined clearance could be defined to also account for expansion and contraction of the modulating body 214 and the cavity 204 resulting from temperature variations that the modulating body 214 and the cavity 204 may experience during operation of the flow control valve 128. It is contemplated that a different (smaller or greater) predefined clearance could be selected to suit each particular application and implementation of the fluid control valve 128 and each particular manufacturing method selected to make the fluid control valve 128.

In the present implementation, the predefined clearance reduces frictional forces that must be overcome by the motor 218 in pivoting the modulating body 214. The predefined clearance also allows the outer wall 602 to selectively block various ones of the inlets and outlets 128a to 128d. That is, the size of the predefined clearance is selected such that when the fluid control valve 128 is in use and the outer wall 602 of the modulating body 214 blocks a given one of the inlets and outlets 128a to 128d, there is either no fluid flow through the given one of the inlets and outlets 128a to 128d, or marginal flow through the given one of the inlets and outlets 128a to 128d.

In the present implementation, some marginal flow is permitted due to the particular example application (HVAC) of the fluid control valve 128. More particularly, in the present implementation, anywhere from 0% to 5% of a design flowrate of glycol solution that a given one of the inlets and outlets 128a to 128d is designed to supply or receive is acceptable when the given one of the inlets and outlets 128a to 128d is in a closed position. In this implementation, a given one of the inlets and outlets 128a to 128d is in a “closed position” when the given one of the inlets and outlets 128a to 128d is blocked by the outer wall 602 of the modulating body 214. A given one of the inlets and outlets 128a to 128d is blocked by the outer wall 602 when the opening 310a to 310d of the given one of the inlets and outlets 128a to 128d is completely covered with the outer wall 602 of the modulating body 214.

For other applications of the fluid control valve 128, the amount of acceptable marginal flow through one or more of the inlets and outlets 128a to 128d of the fluid control valve 128 is determined based on each particular application of the fluid control valve 128. Accordingly, it is contemplated that the predefined clearance may be different than the example predefined clearance described herein above, in order to provide an acceptable amount of marginal flow for a given implementation and application of the fluid control valve 128.

It is also contemplated that for some applications of the fluid control valve 128, no marginal flow (i.e. a marginal flow of zero) may be permitted for one or more of the inlets and outlets 128a to 128d when that one or more of the inlets and outlets 128a to 128d is in a closed position. It is contemplated that in some such cases, additional elements, such as Teflon™ seals, may be required, and could be added to the fluid control valve 128 to provide for zero marginal flow for one or more inlets and outlets 128a to 128d of the fluid control valve 128. In some such cases, the predefined clearance may need to be less than 0.1 millimeters or less.

In another aspect, it is contemplated that the construction and shape of the modulating body 214 and the cavity 204 could differ depending on, for example, each particular implementation and application of the fluid control valve 128. For example, where the fluid control valve 128 is designed to operate at relatively higher fluid pressures, the modulating body 214 and/or the cavity 204 could include one or more seals, such as Teflon™ seals, to provide for a fully fluid-tight contact between the peripheral wall 302 of the cavity 204 and the outer wall 602 of the modulating body 214. As another example, it is contemplated that conventionally known engineering principles could be used to define a different set of shapes and construction of the modulating body 214 and the cavity 204 that would provide for the functionality described herein.

In the present implementation, the passageway 604 and the outer wall 602 of the modulating body 214 are shaped as best shown in FIGS. 6 and 7, to provide the various fluid interconnections between various ones of the inlets and outlets 128a to 128d of the fluid control valve 128. In present implementation, the passageway 604 is defined by a first, larger, lobe 6041 and a second, smaller, lobe 604s that is spaced from the first lobe 6041. The first lobe 6041 and the second lobe 604s extend upward from a bottom portion 608 of the modulating body 214, which bottom portion 608 interconnects the first and second lobes 6041, 604s.

In the present implementation, the first and second lobes 6041, 604s are integral with the bottom portion 608 and the shaft 216 passes through an aperture 610 defined in the first lobe 6041. It is contemplated that the first and second lobes 6041, 604s need not be integral with the bottom portion 608. It is contemplated that the bottom portion 608 could be omitted, in which case the second lobe 604s could be attached to the first lobe 6041 via one or more rigid members (not shown) or another suitable structure, and in which case the outer wall 602 of the modulating body 214 would be defined by an outer wall portion 6121 of the first lobe 6041 and an outer wall portion 612s of the second lobe 604s. It is also contemplated that the shaft 216 need not pass through the first lobe 6041.

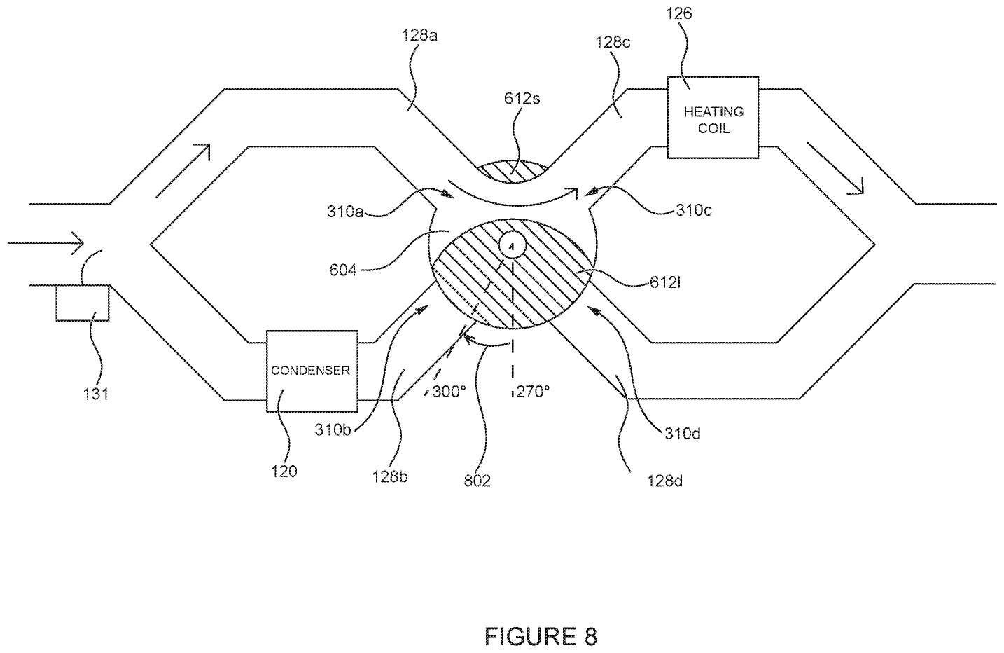

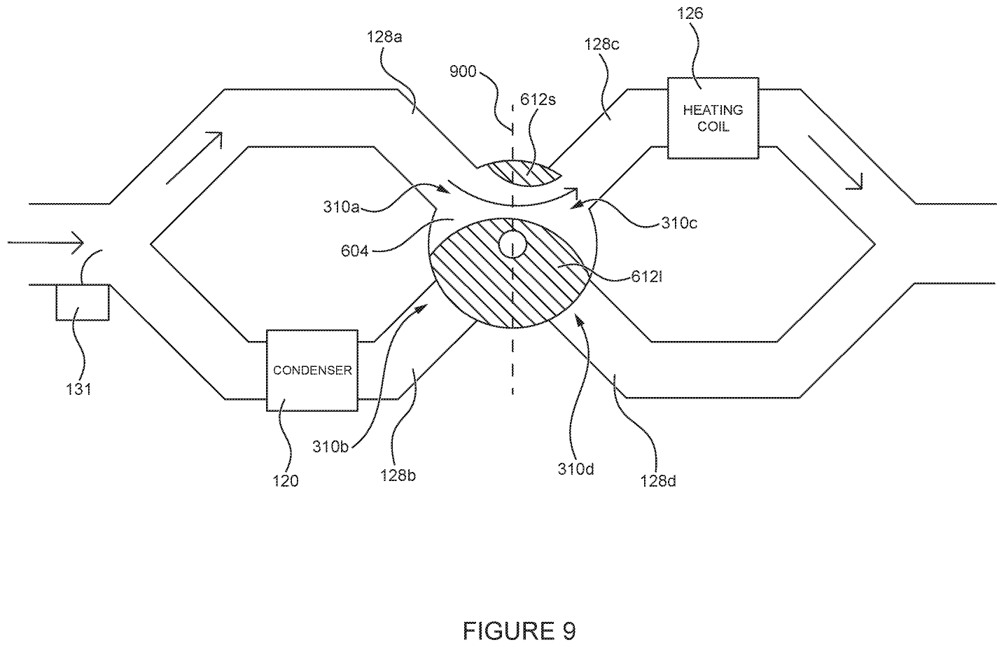

As schematically shown by FIGS. 9, 10 and 14, the outer wall portion 6121 of the first lobe 6041 is shaped to the shape of the peripheral wall 302 of the cavity 204 and to simultaneously fully cover any two of the openings 310a to 310d while having no overlap with any of the other two openings 310a to 310d when the outer wall portion 612s is positioned in front of that opening 310a to 310d. As schematically shown by FIGS. 8 to 14, the outer wall portion 612s is shaped to conform to the shape of the peripheral wall 302 of the cavity 204 and to fully cover any one of the openings 310a to 310d while having no overlap with any of the other openings 310a to 310d when the outer wall portion 612s is positioned in front of that opening 310a to 310d.

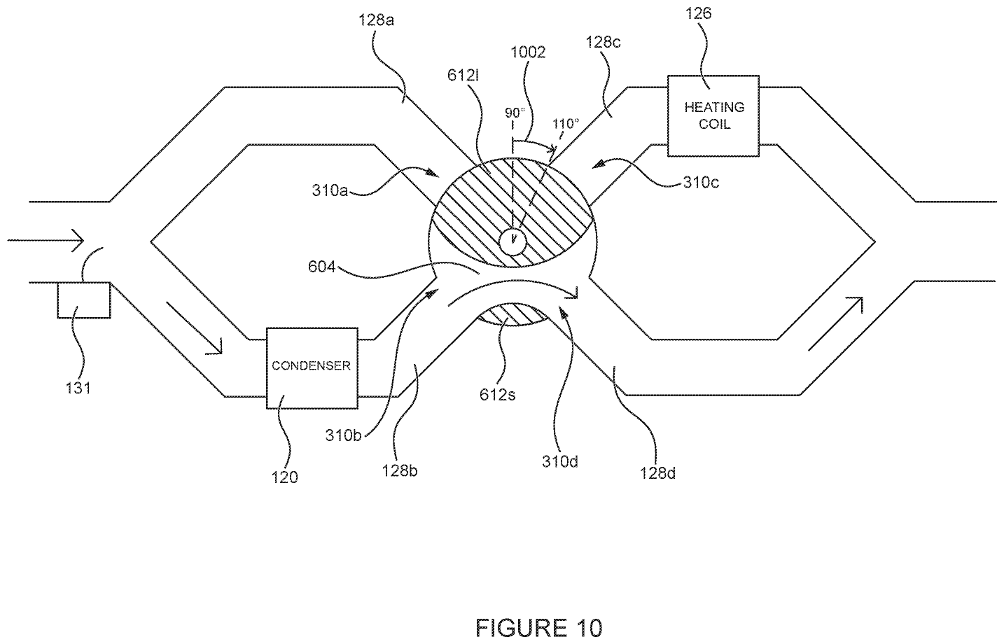

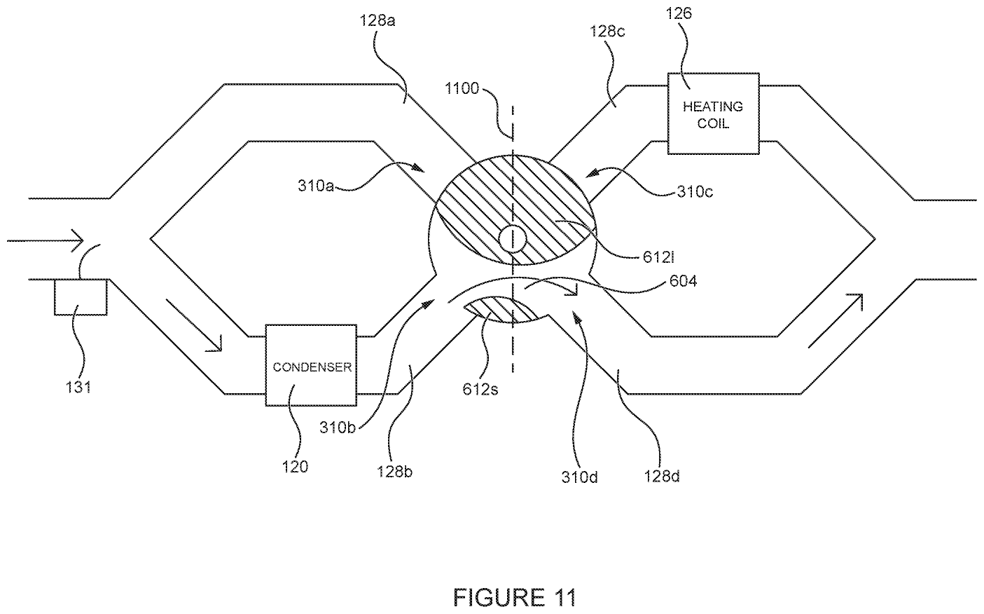

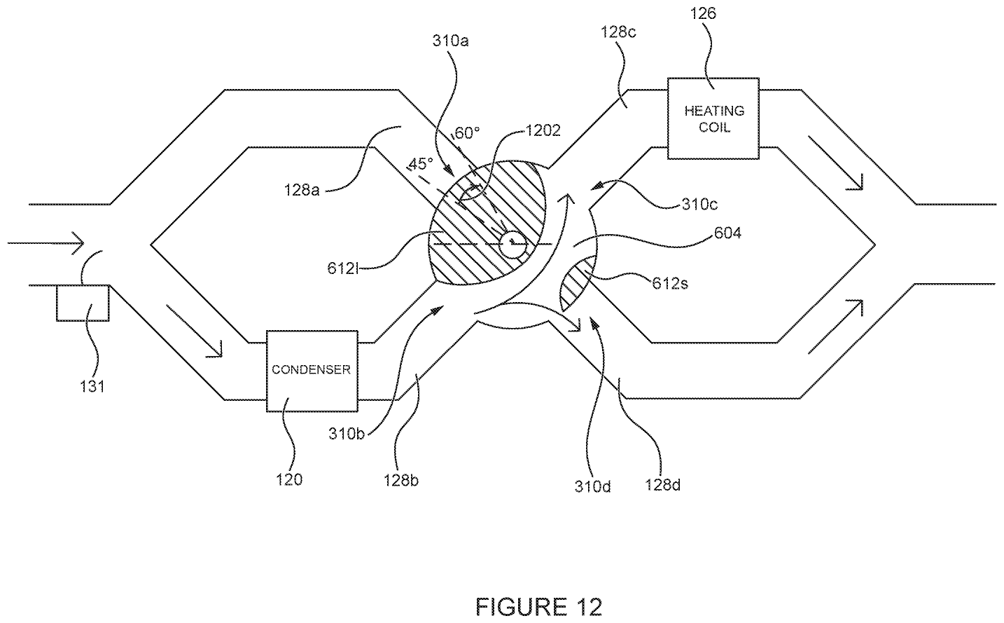

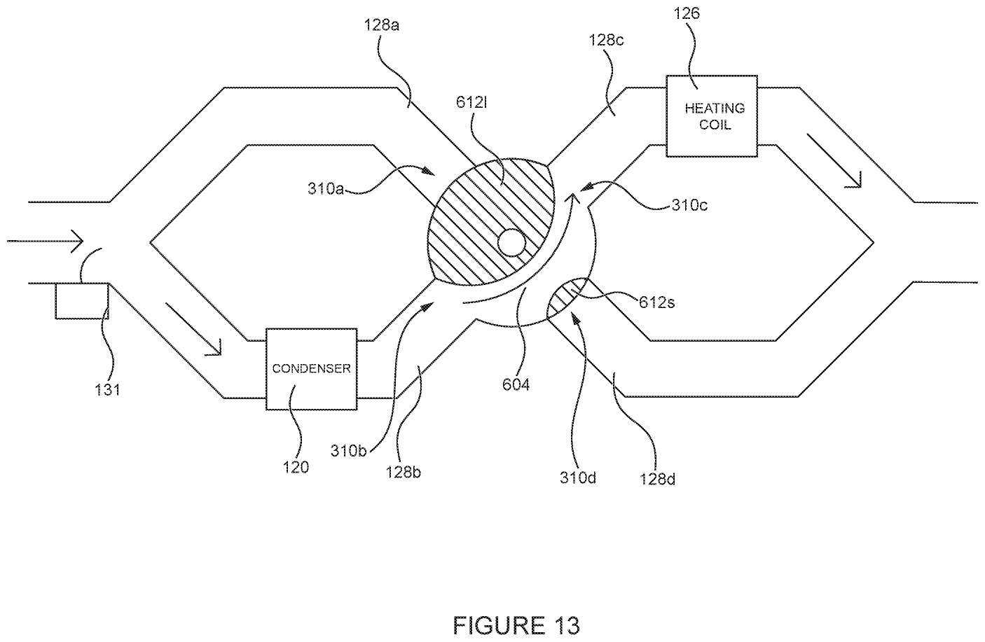

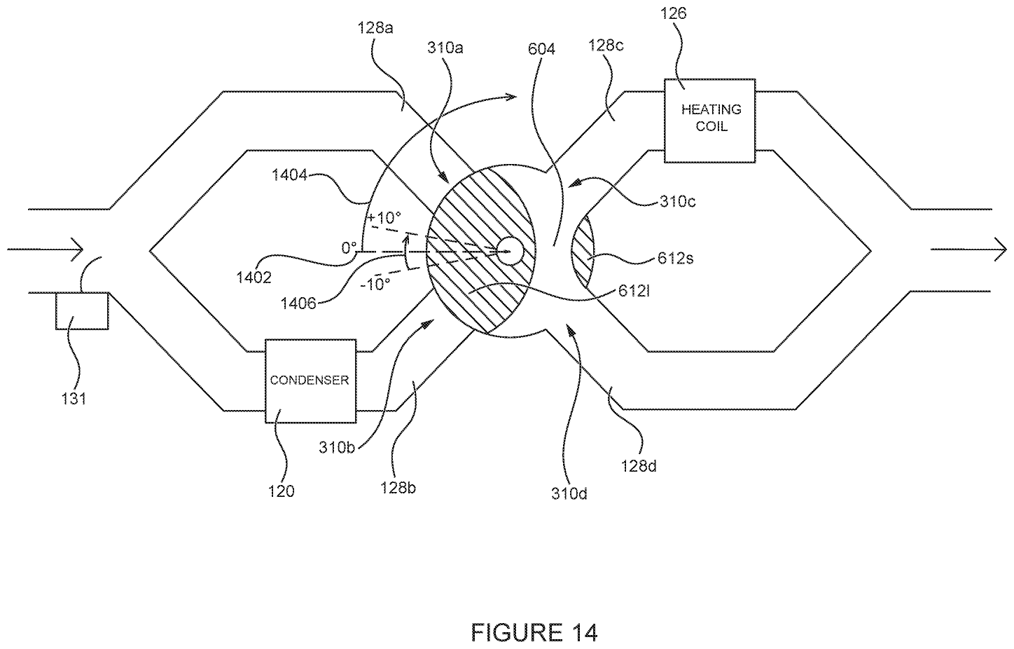

More particularly, in the present implementation, the outer wall portion 6121 and the outer wall portion 612s are positioned relative to each other such that the modulating body 214 is pivotable to each one of: a) an angular position in which the outer wall portion 6121 fully covers the openings 310b and 310d, and the outer wall portion 612s has no overlap with either of the openings 310a and 310c (FIG. 8); b) an angular position in which the outer wall portion 6121 fully covers the openings 310b and 310d, and the outer wall portion 612s has an overlap with the opening 310b (FIG. 9); c) an angular position in which the outer wall portion 6121 fully covers the openings 310b and 310d, and the outer wall portion 612s has an overlap with the opening 310a (not shown, but would be a minor image of the position of FIG. 9, taken about reference line 900 in FIG. 9); d) an angular position in which the outer wall portion 6121 fully covers the openings 310a and 310c, and the outer wall portion 612s has no overlap with either of the openings 310b and 310d (FIG. 10); e) an angular position in which the outer wall portion 6121 fully covers the openings 310a and 310c, and the outer wall portion 612s has an overlap with the opening 310b (FIG. 11); f) an angular position in which the outer wall portion 6121 fully covers the openings 310a and 310c, and the outer wall portion 612s has an overlap with the opening 310d (not shown, but would be a minor image of the position of FIG. 11, taken about reference line 1100 in FIG. 11); g) an angular position in which the outer wall portion 6121 fully covers the opening 310a and has no overlap with any of the other openings 310b, 310c, and 310d, and in which angular position the outer wall portion 612s has an overlap with the opening 310d (FIG. 12); h) an angular position in which the outer wall portion 6121 fully covers the opening 310a and has no overlap with any of the other openings 310b, 310c, and 310d, and in which angular position the outer wall portion 612s fully covers the opening 310d (FIG. 13); and i) an angular position in which the outer wall portion 6121 fully covers the openings 310a and 310b, and the outer wall portion 612s has no overlap with either of the openings 310c and 310d (FIG. 14).

In the present implementation, the final shape of the modulating body 214, the passageway 604 and the relative positions and sizes of the openings 310a to 310d were obtained as follows. SolidWorks™ was used to model, in three-dimensions, the relative shapes and sizes of the peripheral wall 302 of the cavity 204, the openings 310a to 310d, the modulating body 214, and an initial shape of the passageway 604. Then, in the three-dimensional SolidWorks™ model, the modulating body 214 is pivoted about the pivot axis 210, and the resulting fluid interconnections, as well as deviations from the desired fluid interconnections described above were noted. These steps are further referred to herein as validation steps.

Then, the shape, dimensions of the passageway 604 and the relative positions and sizes of the openings 310a to 310d were changed in the three-dimensional model (based on an engineering prediction), and the validation steps were repeated. The steps of changing the shape, dimensions and the relative positions of the above-mentioned elements and the validation steps were repeated iteratively until the final shape of the modulating body 214, the passageway 604 and the relative positions and sizes of the openings 310a to 310d were obtained.

It is contemplated that any other suitable process could be used to select the particular shapes and dimensions of the various parts of the fluid control valve 128. It is also contemplated that the shape of the passageway 604 and/or the outer wall 602 and/or the outer wall portion 6121 and/or the outer wall portion 612s of the modulating body 214 could be different depending on, for example, each particular implementation of the body 202 and/or each particular shape of the cavity 204 and/or the relative positions and sizes of the openings 310a to 310d in the body 202 and/or each particular application of the flow control valve 128. For example, different shapes, and clearances between the various parts of the flow control valve 128 may be selected to suit the operating pressures that each particular implementation of the flow control valve 128 may be designed for.

As shown in FIGS. 8 and 9, when the controller 101 receives a heating call signal from the thermostat 108, the controller 101 pivots the modulating body 214 into a heating range of angular positions 802, which range corresponds to the heating mode of the modulating assembly 212. In the present implementation, the heating range of angular positions is between +(positive) 270° angular degrees and +300° angular degrees relative to a zero (0°) angular degree reference position 1402 of the modulating body 214. The heating range of angular positions 802 is shown approximately in FIG. 8. The modulating body 214 is shown in the zero (0°) angular degree reference position 1402 in FIG. 14.

As shown in FIG. 14 with reference arrow 1404, in the present implementation, positive (+) angular degrees are counted in a clockwise direction 1404 from the zero (0°) angular degree reference position 1402 of the modulating body 214 about the pivot axis about which the modulating body 214 is pivotable. Negative angular degrees are counted in a direction that is opposite to the clockwise direction 1404 about the pivot axis about which the modulating body 214 is pivotable (i.e. negative angular degrees are counted in the counter-clockwise direction).

FIG. 8 shows an example angular position of the modulating body 214 in the heating mode of the modulating assembly 212, and more particularly a 270° angular degree position of the modulating body 214. When the modulating body 214 is in the angular position shown in FIG. 8, the openings 310b and 310d are blocked and the openings 310a and 310c are unrestricted. FIG. 9 shows another example angular position of the modulating body 214 in the heating mode of the modulating assembly 212. When the modulating body 214 is in the angular position shown in FIG. 9, the openings 310b and 310d are blocked, the opening 310a is unrestricted and the opening 310c is partially restricted to provide reduced flow through the opening 310c, and therefore also through the opening 310a. It is contemplated that the heating range of angular positions 802 could be different depending on, for example, the particular size and shape of each particular implementation of the modulating body 214.

When the modulating body 214 is in the heating range of angular positions 802, and as shown in FIGS. 8 and 9, the modulating body 214, and therefore the modulating assembly 212, fluidly connects the first (reheat coil) outlet 128c to the first inlet (from condenser bypass) 128a and maintains the second (reheat coil bypass) outlet 128d and the second inlet (from condenser) 128b in a closed position. More particularly, the passageway 604 fluidly connects the first (reheat coil) outlet 128c to the first inlet (from condenser bypass) 128a, and the outer wall 602 blocks the second (reheat coil bypass) outlet 128d and the second inlet (from condenser) 128b by blocking the openings 310d and 310b, respectively.

In the heating mode, there is either no flow, or marginal flow, of glycol solution through the condenser 120. That is, some fluid pressure differentials experienced by the fluid control valve 128 in some operating conditions of the hydronic system 100 and the fluid circuit 110 may push glycol solution through the predefined clearance, in which case there will be marginal flow through one or both of the openings 310d and 310b while the openings 310d and 310b are blocked by the outer wall 602. On the other hand, other (lower) pressure differentials experienced by the fluid control valve 128 in some operating conditions of the hydronic system 100 may be insufficient to push glycol solution through the predefined clearance, in which case there will be no flow through one or both of the openings 310d and 310b while the openings 310d and 310b are blocked by the outer wall 602.

Accordingly, when the modulating body 214 is in the heating range of angular positions, glycol solution flows from the fluid supply conduit 112 of the fluid circuit 110, through the first inlet (from condenser bypass) 128a to the first (reheat coil) outlet 128c of the fluid control valve 128, then through the hydronic heating coil 126, and then back to the fluid circuit 110 via the fluid return conduit 114. In this mode of operation, the hydronic heating coil 126 heats the air being supplied by the fan 116 to the space 102.

In the heating mode, the controller 101 receives an air temperature signal from the air temperature sensor 129 that represents the supply air temperature, and a flow rate signal from the flow sensor 131 that represents the total glycol solution flow rate through the hydronic system 100. The controller 101 pivots the modulating body 214 in the heating range of angular positions in response to the air temperature signal and the flow rate signal, using a Proportional-Integral control algorithm, to maintain air supplied by the hydronic system 100 to the space 102 at a heating mode supply air temperature setpoint. In the present implementation, the heating mode supply air temperature setpoint is 85 degrees Fahrenheit (approximately 29.4 degrees Celsius). It is contemplated that the heating mode supply air temperature setpoint could be different. It is also contemplated that a different control algorithm, such as a Proportional-Integral-Derivative algorithm, could be used.

As shown in FIG. 9, the controller 101 can pivot the modulating body 214 to reduce the effective size of the opening 310c to modulate flow of glycol solution through the hydronic reheat coil 126. Similarly, the controller 101 can pivot the modulating body 214 to reduce the effective size of the opening 310a to modulate flow of glycol solution through the hydronic reheat coil 126, by pivoting the modulating body 214 until the outer wall 602 blocks at least a part of the opening 310a.

Now referring to FIGS. 10 and 11, when the controller 101 receives a cooling call signal from the thermostat 108, the controller 101 pivots the modulating body 214 into a cooling range of angular positions 1002, which range corresponds to the cooling mode of the modulating assembly 212. In the present implementation, the cooling range of angular positions 1002 is between +90° angular degrees and +110° angular degrees relative to the zero (0°) angular degree reference position 1402 of the modulating body 214. The cooling range of angular positions 1002 is shown approximately in FIG. 10.

FIG. 10 shows an example angular position of the modulating body 214 in the cooling mode of the modulating assembly 212, and more particularly a 90° angular degree position of the modulating body 214. When the modulating body 214 is in the angular position shown in FIG. 10, the openings 310a and 310c are blocked and the openings 310b and 310d are unrestricted. FIG. 11 shows another example angular position of the modulating body 214 in the cooling mode of the modulating assembly 212. When the modulating body 214 is in the angular position shown in FIG. 11, the openings 310a and 310c are blocked, the opening 310b is partially restricted and the opening 310d is unrestricted. It is contemplated that the cooling range of angular positions 1002 could be different depending on, for example, the particular size and shape of each particular implementation of the modulating body 214.

When the modulating body 214 is in the cooling range of angular positions 1002, and as shown in FIGS. 10 and 11, the modulating body 214 (and therefore also the modulating assembly 212) fluidly connects the second (reheat coil bypass) outlet 128d to the second inlet (from condenser) 128b and maintains the first (reheat coil) outlet 128c and the first inlet (from condenser bypass) 128a in a closed position. More particularly, the passageway 604 fluidly connects the second (reheat coil bypass) outlet 128d to the second inlet (from condenser) 128b, and the outer wall 602 blocks the first (reheat coil) outlet 128c and the first inlet (from condenser bypass) 128a by blocking the openings 310c and 310a, respectively.

Accordingly, when the modulating body 214 is in the cooling range of angular positions 1002, glycol solution flows from the fluid supply conduit 112 of the fluid circuit 110, through the condenser 120, through the flow control valve 128 and then back to the fluid circuit 110 via the fluid return conduit 114. In the cooling mode, there is either no flow, or marginal flow of glycol solution through the hydronic heating coil 126 (due to fluid flow and pressure differential principles that are analogous to the fluid flow and pressure differential principles described herein above with respect to openings 310d and 310b).

In another aspect, in the cooling mode, the controller 101 receives the flow rate signal from the flow sensor 131 and pivots the modulating body 214 in the cooling range of angular positions 1002 in response to the flow rate signal, using the conventionally known Proportional-Integral control algorithm, to modulate flow of glycol solution through the condenser 120 to maintain a nominal design flowrate of glycol solution through the condenser 120.

In the present example application of the hydronic system 100, this helps reduce erosion of piping in the condenser 120. That is, in some cases, the fluid circuit 110 serves other systems in addition to the hydronic system 100. In some such cases, one or more of the other systems shuts off and thereby cause pressure of glycol solution supplied to the fluid control valve 128 to rise beyond nominal design pressure. In such cases, the controller 101 reduces the effective size of the opening 310b or 310d by appropriately pivoting the modulating body 214 in the cooling range of angular positions 1002 and thereby maintains the nominal design flowrate of glycol solution through the condenser 120. For example, FIG. 11 shows an angular position of the modulating body 214 which reduces the effective size of the 310b opening.

Referring to FIG. 12, when the controller 101 receives a dehumidification call signal, or a combination of a dehumidification call signal and a heating call signal, from the thermostat 108, the controller 101 pivots the modulating body 214 into a dehumidification range of angular positions 1202, which range corresponds to the dehumidification mode of the modulating assembly 212, and turns on the compressor 122. In the present implementation, the dehumidification range of angular positions 1202 is between +45° (angular degrees) and +60° (angular degrees) relative to the zero (0°) angular degree reference position 1402 of the modulating body 214. The dehumidification range of angular positions 1202 is shown approximately in FIG. 12.

FIG. 12 shows an example angular position of the modulating body 214 in the dehumidification mode, and more particularly a 45° angular degree position of the modulating body 214. When the modulating body 214 is in the angular position shown in FIG. 12, the opening 310a is blocked, the openings 310b and 310c are unrestricted and the opening 310d is partially restricted. It is contemplated that the dehumidification range of angular positions 1202 could be different depending on, for example, the particular size and shape of each particular implementation of the modulating body 214.

When the modulating body 214 is in the dehumidification range of angular positions 1202, and as shown in FIG. 12, the modulating body 214 (and therefore also the modulating assembly 212) fluidly connects the first (reheat coil) outlet 128c and the second (reheat coil bypass) outlet 128d to the second inlet (from condenser) 128b and maintains the first inlet (from condenser bypass) 128a in the closed position. More particularly, the passageway 604 fluidly connects the first (reheat coil) outlet 128c and the second (reheat coil bypass) outlet 128d to the second inlet (from condenser) 128b, and the outer wall 602 blocks the first inlet (from condenser bypass) 128a by blocking the opening 310a.

Accordingly, glycol solution flows from the fluid supply conduit 112 of the fluid circuit 110 through both the condenser 120, the flow control valve 128 and the hydronic heating coil 126, and then back to the fluid circuit 110 via the fluid return conduit 114. In the dehumidification mode, there is either no flow, or marginal flow of glycol solution through the opening 310a (due to fluid flow and pressure differential principles that are analogous to the fluid flow and pressure differential principles described herein above with respect to openings 310a and 310c).

In the dehumidification mode, air entering the hydronic system 100 is first cooled (and dehumidified) by the DX coil 118, and then re-heated by the hydronic heating coil 126 to a dehumidification supply air temperature setpoint. In one example set of operating conditions, 75 degree Fahrenheit (approximately 23.9 degrees Celsius) air enters the DX coil 118, is cooled by the DX coil 118 to 55 degrees Fahrenheit (approximately 12.8 degrees Celsius), and is then re-heated to 70 degrees Fahrenheit (approximately 21.1 degrees Celsius). It is contemplated that these setpoints could be different, depending on, for example, each particular application of the hydronic system 100.

In the dehumidification mode, the controller 101 receives the air temperature signal from the air temperature sensor 129 and the flow rate signal from the flow sensor 131. The controller 101 pivots the modulating body 214 in the dehumidification range of angular positions 1202 in response to the air temperature signal and the flow rate signal, using the conventionally known Proportional-Integral control algorithm, to provide air to the space 102 at the dehumidification air temperature setpoint.

In an aspect, the controller 101 modulates flow of glycol solution through the hydronic reheat coil 126, by appropriately pivoting the modulating body 214 in the dehumidification range of angular positions 1202, to vary the heat output of the hydronic reheat coil 126 and thereby maintain the supply air at the dehumidification air temperature setpoint. In the present implementation, the modulating body 214 can modulate flow of glycol solution through the hydronic reheat coil 126 by reducing the effective size of the opening 310d (as shown in FIG. 12) or the effective size of the opening 310b.

In some cases, the controller 101 determines that all available flow of glycol solution should be sent first through the condenser 120 and then through the hydronic reheat coil 126 (for example, when the space(s) served by the hydronic system 100 has/have a high humidity and require heating at the same time). In such cases, the controller 101 places the modulating assembly 212 into a full flow dehumidification mode, an example of which is shown in FIG. 13. When the modulating body 214 is in the angular position shown in FIG. 13, the openings 310a and 310d are blocked and the openings 310b and 310c are unrestricted.

In the full flow dehumidification mode, the modulating body 214 (and therefore also the modulating assembly 212) fluidly connects the first (reheat coil) outlet 128c to the second inlet (from condenser) 128b and maintains the first inlet (from condenser bypass) 128a and the second (reheat coil bypass) outlet 128d in the closed position. More particularly, the passageway 604 fluidly connects the first (reheat coil) outlet 128c to the second inlet (from condenser) 128b, and the outer wall 602 blocks the first inlet (from condenser bypass) 128a and the second (reheat coil bypass) outlet 128d by blocking the openings 310a and 310d, respectively. In this angular position, the opening 310c via which the first (reheat coil) outlet 128c is fluidly connected to the cavity 204 is fully open, and the opening 310b via which the second inlet (from condenser) 128b is fluidly connected to the cavity 204 is fully open. In some implementations, the fluid control valve 128 does not have a full flow dehumidification mode.

In some cases, the thermostat 108 produces a combination of a dehumidification call signal and a cooling call signal (for example, when the hotel room 102 has high air humidity simultaneously with a high cooling load requirement). In such cases, the controller 101 pivots the modulating body 214 into the cooling range of angular positions 1002 and operates as described herein above with respect to the cooling mode.

Now referring to FIG. 14, when the controller 101 receives no signals from the thermostat 108 (for example, when the thermostat 108 loses power or when the air in the hotel room 102 does not require any heating, cooling or dehumidifying), the controller 101 pivots the modulating body 214 into an angular position that is in a shut-off range of angular positions 1406. The shut-off range of angular positions 1406 corresponds to the shut-off mode of the modulating assembly 212. In the present implementation, the shut-off range of angular positions 1406 is between −10° (negative ten) angular degrees and +10° (positive ten) angular degrees relative to the zero (0°) reference position of the modulating body 214.

FIG. 14 shows an example angular position of the modulating body 214 in the shut-off mode, and more particularly the 0° angular degree position 1402 of the modulating body 214. It is contemplated that the shut-off range of angular positions 1406 could be different depending on, for example, the particular size and shape of each particular implementation of the modulating body 214. In some implementations of the fluid control valve 128, the modulating body 214 has only one shut-off angular position which corresponds to the shut-off mode of the modulating assembly 212.

When the modulating assembly 212 is in the shut-off mode, the modulating body 214 (and therefore also the modulating assembly 212) maintains the first inlet (from condenser bypass) 128a and the second inlet (from condenser) 128b in the closed position. Accordingly, when the modulating body 214 is in the shut-off range of angular positions 1406, there is either no flow or marginal flow (due to fluid flow and pressure differential principles that are analogous to the fluid flow and pressure differential principles described herein above with respect to openings 310a and 310c) of glycol solution through both the condenser 120 and the hydronic heating coil 126.

In another aspect, the controller 101 controls the operation of the fan 116 using a heat pump fan control algorithm. It is contemplated that the controller 101 could have additional electronic connections to additional devices and could be programmed with additional control sequences, depending on each particular application of the hydronic system 100.

Implementations of the present technology can be represented as presented in the following numbered clauses.

CLAUSE 1. A flow control valve, comprising: a body defining a cavity therein, the cavity having a peripheral wall positioned radially about a pivot axis, a first outlet fluidly connected to the cavity via a first opening defined in the peripheral wall of the cavity, a second outlet fluidly connected to the cavity via a second opening defined in the peripheral wall of the cavity, a first inlet fluidly connected to the cavity via a third opening defined in the peripheral wall of the cavity, and a second inlet fluidly connected to the cavity via a fourth opening defined in the peripheral wall of the cavity; and a modulating body disposed at least in part in the cavity, the modulating body being pivotable about the pivot axis, the modulating body having an outer wall and a passageway defined therethrough, the passageway and the outer wall of the modulating body being shaped such that the modulating body is pivotable about the pivot axis in: a) a first range of angular positions, in which i) the passageway fluidly connects the first outlet to the first inlet, and ii) the outer wall of the modulating body blocks the second opening and the fourth opening; b) a second range of angular positions, in which i) the passageway fluidly connects the second outlet to the second inlet, and ii) the outer wall of the modulating body blocks the first and the third opening; c) a third range of angular positions, in which i) the passageway fluidly connects the first outlet and the second outlet to the second inlet, and ii) the outer wall of the modulating body blocks the third opening; and d) a fourth position, in which the outer wall of the modulating body blocks the third opening and the fourth opening.

CLAUSE 2. The flow control valve of clause 1, further comprising an actuator mounted to the body of the flow control valve, the actuator being operatively connected to the modulating body to pivot the modulating body about the pivot axis: a) in the first range of angular positions, the second range of angular positions and the third range of angular positions, and b) to the fourth position.

CLAUSE 3. The flow control valve of clause 1 or 2, wherein the passageway and the outer wall of the modulating body are shaped such that the modulating body is pivotable within the first range of angular positions to block a part of the first opening with the outer wall of the modulating body to modulate fluid flow through the first opening.

CLAUSE 4. The flow control valve of any one of clauses 1 to 3, wherein the passageway and the outer wall of the modulating body are shaped such that the modulating body is pivotable within the first range of angular positions to block a part of the third opening with the outer wall of the modulating body to modulate fluid flow through the first opening.

CLAUSE 5. The flow control valve of any one of clauses 1 to 4, wherein the passageway and the outer wall of the modulating body are shaped such that the modulating body is pivotable within the second range of angular positions to block a part of the fourth opening with the outer wall of the modulating body to modulate fluid flow through the second opening.

CLAUSE 6. The flow control valve of any one of clauses 1 to 5, wherein the passageway and the outer wall of the modulating body are shaped such that the modulating body is pivotable within the second range of angular positions to block a part of the second opening with the outer wall of the modulating body to modulate fluid flow through the second opening.

CLAUSE 7. The flow control valve of any one of clauses 1 to 6, wherein the passageway and the outer wall of the modulating body are shaped such that the modulating body is pivotable within the third range of angular positions to block a part of the second opening with the outer wall of the modulating body to modulate fluid flow through the second opening.

CLAUSE 8. The flow control valve of any one of clauses 1 to 7, wherein the passageway and the outer wall of the modulating body are shaped such that the modulating body is pivotable within the third range of angular positions to block a part of the fourth opening with the outer wall of the modulating body to modulate fluid flow through the second opening.

CLAUSE 9. The flow control valve of any one of clauses 1 to 8, wherein: a) the modulating body is generally cylindrical; b) the outer wall of the modulating body is a sidewall of the modulating body, the sidewall being parallel to the pivot axis; c) the peripheral wall of the cavity defines a cylindrical shape; d) the pivot axis passes through a centre of the modulating body and through a centre of the cylindrical shape of the peripheral wall; and e) the sidewall of the cylinder and the peripheral wall of the cavity are shaped such that there is a predetermined clearance between the sidewall of the cylinder and the peripheral wall of the cavity.

CLAUSE 10. The flow control valve of clause 9, wherein the predetermined clearance is in a range of 0.001 to 1.000 millimeters.

CLAUSE 11. A hydronic system comprising the flow control valve of any one of clauses 1 to 10, wherein the hydronic system has: a) a fan operable to create an airstream; b) a refrigeration circuit, the refrigerant circuit including: i) a condenser having a condenser fluid inlet conduit and a condenser fluid outlet conduit, the condenser fluid outlet conduit being fluidly connected to the second inlet of the flow control valve, ii) a compressor, iii) an expansion valve, and iv) a direct expansion coil, the direct expansion coil being connected to the fan via an air conduit such that the airstream passes through the direct expansion coil, the condenser, the compressor, the expansion valve, and the direct expansion coil being interconnected via a refrigerant conduit such that when the refrigerant circuit is charged with a predetermined quantity of refrigerant, the refrigerant circuit is operable to cool the direct expansion coil to cool the airstream; c) a hydronic heating coil, the hydronic heating coil: i) having a hydronic heating coil inlet conduit and a hydronic heating coil outlet conduit, the hydronic heating coil inlet conduit being fluidly connected to the first outlet of the flow control valve, and ii) being connected to the fan via the air conduit downstream of the direct expansion coil such that the airstream passes through the hydronic heating coil after passing through the direct expansion coil, and iii) being operable to heat the airstream passing through the hydronic heating coil; d) a hydronic heating coil bypass conduit fluidly connecting the second outlet of the flow control valve to the hydronic heating coil outlet conduit; and e) a condenser bypass conduit fluidly connecting the condenser fluid inlet conduit to the first inlet of the flow control valve.

CLAUSE 12. The hydronic system of clause 11, wherein the fan is one of: a) downstream of the hydronic heating coil in the air conduit; b) in between the direct expansion coil and the hydronic heating coil in the air conduit; and c) upstream of the direct expansion coil in the air conduit.

CLAUSE 13. The hydronic system of clause 11 or 12, further comprising: a) a modulating assembly, the modulating assembly including the modulating body of the flow control valve, a motor and a gear train, the gear train operatively connecting the motor to the modulating body to pivot the modulating body about the pivot axis; b) a flow sensor, the flow sensor being: i) fluidly connected to the first inlet of the flow control valve and the condenser fluid inlet conduit fluidly upstream of the first inlet of the flow control valve and the condenser fluid inlet conduit, and ii) operable to generate a flowrate signal representative of a sum of fluid flowrates through the first inlet of the flow control valve and the condenser fluid inlet conduit; c) an air temperature sensor, the air temperature sensor being: i) positioned at least in part in the air conduit downstream of the hydronic heating coil, and ii) operable to generate an air temperature signal representative of a temperature of the airstream downstream of the hydronic heating coil; and d) a controller, the controller being: i) in electronic communication with the motor of the modulating assembly, the flow sensor and the air temperature sensor, and ii) operable to actuate the motor of the modulating assembly in response to the flowrate signal and the air temperature signal to pivot the modulating body in the first range of angular positions, the second range of angular positions and the third range of angular positions, and to the fourth position.

CLAUSE 14. The hydronic system of clause 13, further comprising a thermostat, the thermostat being operable to generate a heating call signal, a cooling call signal and a dehumidification call signal, the controller being in electronic communication with the thermostat and being operable to actuate the motor to pivot the modulating body: a) in the first range of angular positions in response to receiving the heating call signal from the thermostat; b) in the second range of angular positions in response to receiving the cooling call signal from the thermostat; c) in the third range of angular positions in response to receiving the dehumidification signal from the thermostat; and d) to the fourth position in response to receiving no signal from the thermostat.

CLAUSE 15. The hydronic system of clause 14, wherein: a) the thermostat is operable to generate: i) a combination of the heating call signal and the dehumidification call signal, and ii) a combination of the cooling call signal and the dehumidification call signal; and b) the controller is operable to actuate the motor to pivot the modulating body: I) in the third range of angular positions in response to the combination of the heating call signal and the dehumidification call signal, and II) in the second range of angular positions in response to the combination of the cooling call signal and the dehumidification call signal.

CLAUSE 16. A flow control valve, comprising: a) a body defining: a cavity therein, a first outlet in fluid communication with the cavity, a second outlet in fluid communication with the cavity, a first inlet in fluid communication with the cavity, and a second inlet in fluid communication with the cavity; and b) modulating means being disposed at least in part in the cavity and being operable in: i) a first mode, in which the modulating means fluidly connects the first outlet to the first inlet and maintains the second outlet and the second inlet in a closed position, the closed position of the second outlet providing one of: no flow, and marginal flow of fluid through the second outlet, the closed position of the second inlet providing one of: no flow, and marginal flow of fluid through the second inlet; ii) a second mode, in which the modulating means fluidly connects the second outlet to the second inlet and maintains the first outlet and the first inlet in a closed position, the closed position of the first outlet providing one of: no flow, and marginal flow of fluid through the first outlet, the closed position of the first inlet providing one of: no flow, and marginal flow of fluid through the first inlet; c) a third mode, in which the modulating means fluidly connects the first outlet and the second outlet to the second inlet and maintains the first inlet in the closed position; and d) a fourth mode, in which the modulating means maintains the first inlet and the second inlet in the closed position.

CLAUSE 17. The flow control valve of clause 16, wherein the modulating means is operable in a fifth mode, in which the modulating means fluidly connects the first outlet to the second inlet and maintains the first inlet and the second outlet in the closed position.

CLAUSE 18. The flow control valve of clause 16 or 17, wherein the modulating means is operable to modulate fluid flow through the first outlet when the modulating means is in the first mode.

CLAUSE 19. The flow control valve of any one of clauses 16 to 18, wherein the modulating means is operable to modulate fluid flow through the first inlet when the modulating means is in the first mode.

CLAUSE 20. The flow control valve of any one of clauses 16 to 19, wherein the modulating means is operable to modulate fluid flow through the second outlet when the modulating means is in the second mode.

CLAUSE 21. The flow control valve of any one of clauses 16 to 20, wherein the modulating means is operable to modulate fluid flow through the second inlet when the modulating means is in the second mode.

CLAUSE 22. The flow control valve of any one of clauses 16 to 21, wherein the modulating means is operable to modulate fluid flow through the second outlet when the modulating means is in the third mode.

CLAUSE 23. The flow control valve of any one of clauses 16 to 22, wherein the modulating means is operable to modulate fluid flow through the second inlet when the modulating means is in the third mode.

CLAUSE 24. The flow control valve of any one of clauses 16 to 23, wherein: the cavity has a peripheral wall positioned radially about a pivot axis, the pivot axis passing through the body of the flow control valve; the first outlet, the second outlet, the first inlet and the second inlet are defined in the peripheral wall of the cavity; the modulating means includes a modulating body, the modulating body having an outer wall and a passageway defined therethrough, the modulating body being pivotable about the pivot axis; and the outer wall of the modulating body and the passageway are shaped such that: a) when the modulating means is in the first mode, the passageway fluidly connects the first outlet to the first inlet, and the outer wall of the modulating body blocks the second outlet and the second inlet such that there is one of: no flow, and marginal flow of fluid through the second outlet and the second inlet; b) when the modulating means is in the second mode, the passageway fluidly connects the second outlet to the second inlet, and the outer wall of the modulating body blocks the first outlet and the first inlet such that there is one of: no flow, and marginal flow of fluid through the first outlet and the first inlet; c) when the modulating means is in the third mode, the passageway fluidly connects the first outlet and the second outlet to the second inlet, and the outer wall of the modulating body blocks the first inlet such that there is one of: no flow, and marginal flow of fluid through the first inlet; and d) when the modulating means is in the fourth mode, the outer wall of the modulating body blocks the first inlet and the second inlet such that there is one of: no flow, and marginal flow of fluid through the first inlet and the second inlet.

CLAUSE 25. The flow control valve of clause 24, wherein: the first outlet is fluidly connected to the cavity via a first opening defined in the peripheral wall of the cavity; the second inlet is fluidly connected to the cavity via a second opening defined in the peripheral wall of the cavity, the second opening being different from the first opening; the passageway has a first open end defined in the outer wall of the modulating body and a second open end defined in the outer wall of the modulating body, the second open end being fluidly connected to the first open end; and the outer wall of the modulating body and the passageway are shaped such that when the modulating means is in the fifth mode, i) the first opening is fully open to the first open end of the passageway, ii) the second opening is fully open to the second open end of the passageway, and ii) the outer wall of the modulating body blocks the first inlet and the second outlet.

CLAUSE 26. The flow control valve of clause 25, wherein the modulating means further includes a motor mounted to the body of the flow control valve, and a gear train that operatively connects the motor to the modulating body to pivot the modulating body about the pivot axis.

CLAUSE 27. A hydronic system comprising the flow control valve of clause 26, wherein the hydronic system has: a) a fan operable to create an airstream; b) a refrigerant circuit, the refrigerant circuit including: i) a condenser having a condenser fluid inlet conduit and a condenser fluid outlet conduit, the condenser fluid outlet conduit being fluidly connected to the second inlet of the flow control valve, ii) a compressor, iii) an expansion valve, and iv) a direct expansion coil, the direct expansion coil being connected to the fan via an air conduit such that the airstream passes through the direct expansion coil, the condenser, the compressor, the expansion valve, and the direct expansion coil being interconnected via a refrigerant conduit such that when the refrigerant circuit is charged with a predetermined quantity of refrigerant, the refrigerant circuit is operable to cool the direct expansion coil to cool airstream; c) a hydronic heating coil, the hydronic heating coil: i) having a hydronic heating coil inlet conduit and a hydronic heating coil outlet conduit, the hydronic heating coil inlet conduit being fluidly connected to the first outlet of the flow control valve, ii) being connected to the fan via the air conduit downstream of the direct expansion coil such that the airstream passes through the hydronic heating coil after passing through the direct expansion coil, and iii) being operable to heat the airstream passing through the hydronic heating coil; d) a hydronic heating coil bypass conduit fluidly connecting the second outlet of the flow control valve to the hydronic heating coil outlet conduit; and e) a condenser bypass conduit fluidly connecting the condenser fluid inlet conduit to the first inlet of the flow control valve.

CLAUSE 28. The hydronic system of clause 27, wherein the fan is one of: a) downstream of the hydronic heating coil in the air conduit; b) in between the direct expansion coil and the hydronic heating coil in the air conduit; and c) upstream of the direct expansion coil in the air conduit.

CLAUSE 29. The hydronic system of clause 27, further comprising: a) a flow sensor, the flow sensor being: i) fluidly connected to the first inlet of the flow control valve and the condenser fluid inlet conduit fluidly upstream of the first inlet of the flow control valve and the condenser fluid inlet conduit, and ii) operable to generate a flowrate signal representative of a sum of fluid flowrates through the first inlet of the flow control valve and the condenser fluid inlet conduit; b) an air temperature sensor, the air temperature sensor being: i) positioned at least in part in the air conduit downstream of the hydronic heating coil, and ii) operable to generate an air temperature signal representative of a temperature of the airstream downstream of the hydronic heating coil; and c) a controller, the controller being: i) in electronic communication with the motor, the flow sensor and the air temperature sensor, and ii) operable to actuate the motor in response to the flowrate signal and the air temperature signal to pivot the modulating body: I) in a first range of angular positions corresponding to the first mode, II) a second range of angular positions corresponding to the second mode, III) a third range of angular positions corresponding to the third mode, and W) to a fourth position corresponding to the fourth mode.

CLAUSE 30. The hydronic system of clause 29, wherein the controller is operable to actuate the motor in response to the flowrate signal and the air temperature signal to pivot the modulating body to a full dehumidification flow position in which: a) the passageway of the modulating body fluidly connects the first outlet to the second inlet, and b) the outer wall of the modulating body blocks the first inlet and the second outlet in the closed position.

CLAUSE 31. The hydronic system of clause 29 or 30, further comprising a thermostat, the thermostat being operable to generate a heating call signal, a cooling call signal and a dehumidification call signal, the controller being in electronic communication with the thermostat and being operable to actuate the motor to pivot the modulating body: a) in the first range of angular positions in response to receiving the heating call signal from the thermostat; b) in the second range of angular positions in response to receiving the cooling call signal from the thermostat; c) in the third range of angular positions in response to receiving the dehumidification signal from the thermostat, and d) to the fourth position in response to receiving no signal from the thermostat.

CLAUSE 32. The hydronic system of clause 31, wherein: a) the thermostat is operable to generate: i) a combination of the heating call signal and the dehumidification call signal, and ii) a combination of the cooling call signal and the dehumidification call signal; and b) the controller is operable to actuate the motor to pivot the modulating body: I) in the third range of angular positions in response to the combination of the heating call signal and the dehumidification call signal, and II) in the second range of angular positions in response to the combination of the cooling call signal and the dehumidification call signal.

Modifications and improvements to the above-described implementations of the present technology may become apparent to those skilled in the art. The foregoing description is intended to be exemplary rather than limiting.

1. A flow control valve, comprising:
a body defining:
a cavity therein, the cavity having a peripheral wall positioned radially about a pivot axis,
a first outlet fluidly connected to the cavity via a first opening defined in the peripheral wall of the cavity,
a second outlet fluidly connected to the cavity via a second opening defined in the peripheral wall of the cavity,
a first inlet fluidly connected to the cavity via a third opening defined in the peripheral wall of the cavity, and
a second inlet fluidly connected to the cavity via a fourth opening defined in the peripheral wall of the cavity; and
a modulating body disposed at least in part in the cavity, the modulating body being pivotable about the pivot axis, the modulating body having an outer wall and a passageway defined therethrough, the passageway and the outer wall of the modulating body being shaped such that the modulating body is pivotable about the pivot axis in:
a) a first range of angular positions, in which
i) the passageway fluidly connects the first outlet to the first inlet, and
ii) the outer wall of the modulating body blocks the second opening and the fourth opening;
b) a second range of angular positions, in which
i) the passageway fluidly connects the second outlet to the second inlet, and
ii) the outer wall of the modulating body blocks the first and the third opening;
c) a third range of angular positions, in which
i) the passageway fluidly connects the first outlet and the second outlet to the second inlet, and
ii) the outer wall of the modulating body blocks the third opening; and
d) a fourth position, in which the outer wall of the modulating body blocks the third opening and the fourth opening.

2. The flow control valve of claim 1, further comprising an actuator mounted to the body of the flow control valve, the actuator being operatively connected to the modulating body to pivot the modulating body about the pivot axis:
a) in the first range of angular positions, the second range of angular positions and the third range of angular positions, and
b) to the fourth position.

3. The flow control valve of claim 2, wherein the passageway and the outer wall of the modulating body are shaped such that the modulating body is pivotable within the first range of angular positions to block a part of the first opening with the outer wall of the modulating body to modulate fluid flow through the first opening.

4. The flow control valve of claim 3, wherein the passageway and the outer wall of the modulating body are shaped such that the modulating body is pivotable within the first range of angular positions to block a part of the third opening with the outer wall of the modulating body to modulate fluid flow through the first opening.

5. The flow control valve of claim 4, wherein the passageway and the outer wall of the modulating body are shaped such that the modulating body is pivotable within the second range of angular positions to block a part of the fourth opening with the outer wall of the modulating body to modulate fluid flow through the second opening.

6. The flow control valve of claim 5, wherein the passageway and the outer wall of the modulating body are shaped such that the modulating body is pivotable within the second range of angular positions to block a part of the second opening with the outer wall of the modulating body to modulate fluid flow through the second opening.

7. The flow control valve of claim 6, wherein the passageway and the outer wall of the modulating body are shaped such that the modulating body is pivotable within the third range of angular positions to block a part of the second opening with the outer wall of the modulating body to modulate fluid flow through the second opening.

8. The flow control valve of claim 7, wherein the passageway and the outer wall of the modulating body are shaped such that the modulating body is pivotable within the third range of angular positions to block a part of the fourth opening with the outer wall of the modulating body to modulate fluid flow through the second opening.

9. The flow control valve of claim 8, wherein:
a) the modulating body is generally cylindrical;
b) the outer wall of the modulating body is a sidewall of the modulating body, the sidewall being parallel to the pivot axis;
c) the peripheral wall of the cavity defines a cylindrical shape;
d) the pivot axis passes through a centre of the modulating body and through a centre of the cylindrical shape of the peripheral wall; and
e) the sidewall of the cylinder and the peripheral wall of the cavity are shaped such that there is a predetermined clearance between the sidewall of the cylinder and the peripheral wall of the cavity.

10. (canceled)

11. A hydronic system comprising the flow control valve of claim 1, wherein the hydronic system has:
a) a fan operable to create an airstream;
b) a refrigeration circuit, the refrigerant circuit including:
i) a condenser having a condenser fluid inlet conduit and a condenser fluid outlet conduit, the condenser fluid outlet conduit being fluidly connected to the second inlet of the flow control valve,
ii) a compressor,
iii) an expansion valve, and
iv) a direct expansion coil, the direct expansion coil being connected to the fan via an air conduit such that the airstream passes through the direct expansion coil,
the condenser, the compressor, the expansion valve, and the direct expansion coil being interconnected via a refrigerant conduit such that when the refrigerant circuit is charged with a predetermined quantity of refrigerant, the refrigerant circuit is operable to cool the direct expansion coil to cool the airstream;
c) a hydronic heating coil, the hydronic heating coil:
i) having a hydronic heating coil inlet conduit and a hydronic heating coil outlet conduit, the hydronic heating coil inlet conduit being fluidly connected to the first outlet of the flow control valve, and
ii) being connected to the fan via the air conduit downstream of the direct expansion coil such that the airstream passes through the hydronic heating coil after passing through the direct expansion coil, and
iii) being operable to heat the airstream passing through the hydronic heating coil;
d) a hydronic heating coil bypass conduit fluidly connecting the second outlet of the flow control valve to the hydronic heating coil outlet conduit; and
e) a condenser bypass conduit fluidly connecting the condenser fluid inlet conduit to the first inlet of the flow control valve.

12. (canceled)

13. The hydronic system of claim 11, further comprising:
a) a modulating assembly, the modulating assembly including the modulating body of the flow control valve, a motor and a gear train, the gear train operatively connecting the motor to the modulating body to pivot the modulating body about the pivot axis;
b) a flow sensor, the flow sensor being:
i) fluidly connected to the first inlet of the flow control valve and the condenser fluid inlet conduit fluidly upstream of the first inlet of the flow control valve and the condenser fluid inlet conduit, and
ii) operable to generate a flowrate signal representative of a sum of fluid flowrates through the first inlet of the flow control valve and the condenser fluid inlet conduit;
c) an air temperature sensor, the air temperature sensor being:
i) positioned at least in part in the air conduit downstream of the hydronic heating coil, and
ii) operable to generate an air temperature signal representative of a temperature of the airstream downstream of the hydronic heating coil; and
d) a controller, the controller being:
i) in electronic communication with the motor of the modulating assembly, the flow sensor and the air temperature sensor, and
ii) operable to actuate the motor of the modulating assembly in response to the flowrate signal and the air temperature signal to pivot the modulating body in the first range of angular positions, the second range of angular positions and the third range of angular positions, and to the fourth position.

14. The hydronic system of claim 13, further comprising a thermostat, the thermostat being operable to generate a heating call signal, a cooling call signal and a dehumidification call signal, the controller being in electronic communication with the thermostat and being operable to actuate the motor to pivot the modulating body:
a) in the first range of angular positions in response to receiving the heating call signal from the thermostat;
b) in the second range of angular positions in response to receiving the cooling call signal from the thermostat;
c) in the third range of angular positions in response to receiving the dehumidification signal from the thermostat; and
d) to the fourth position in response to receiving no signal from the thermostat.

15. (canceled)

16. A flow control valve, comprising:
a) a body defining:
a cavity therein,
a first outlet in fluid communication with the cavity,
a second outlet in fluid communication with the cavity,
a first inlet in fluid communication with the cavity, and
a second inlet in fluid communication with the cavity; and
b) modulating means being disposed at least in part in the cavity and being operable in:
i) a first mode, in which the modulating means fluidly connects the first outlet to the first inlet and maintains the second outlet and the second inlet in a closed position,
the closed position of the second outlet providing one of: no flow, and marginal flow of fluid through the second outlet,
the closed position of the second inlet providing one of: no flow, and marginal flow of fluid through the second inlet;
ii) a second mode, in which the modulating means fluidly connects the second outlet to the second inlet and maintains the first outlet and the first inlet in a closed position,
the closed position of the first outlet providing one of: no flow, and marginal flow of fluid through the first outlet,
the closed position of the first inlet providing one of: no flow, and marginal flow of fluid through the first inlet;
c) a third mode, in which the modulating means fluidly connects the first outlet and the second outlet to the second inlet and maintains the first inlet in the closed position; and
d) a fourth mode, in which the modulating means maintains the first inlet and the second inlet in the closed position.

17. The flow control valve of claim 16, wherein the modulating means is operable in a fifth mode, in which the modulating means fluidly connects the first outlet to the second inlet and maintains the first inlet and the second outlet in the closed position.

18. The flow control valve of claim 17, wherein the modulating means is operable to modulate fluid flow through the first outlet when the modulating means is in the first mode.

19. The flow control valve of claim 16, wherein the modulating means is operable to modulate fluid flow through the first inlet when the modulating means is in the first mode.

20. The flow control valve of claim 16, wherein the modulating means is operable to modulate fluid flow through the second outlet when the modulating means is in the second mode.

21. The flow control valve of claim 16, wherein the modulating means is operable to modulate fluid flow through the second inlet when the modulating means is in the second mode.

22. The flow control valve of claim 16, wherein the modulating means is operable to modulate fluid flow through the second outlet when the modulating means is in the third mode.

23. The flow control valve of claim 16, wherein the modulating means is operable to modulate fluid flow through the second inlet when the modulating means is in the third mode.

24. The flow control valve of claim 16, wherein:
the cavity has a peripheral wall positioned radially about a pivot axis, the pivot axis passing through the body of the flow control valve;
the first outlet, the second outlet, the first inlet and the second inlet are defined in the peripheral wall of the cavity;
the modulating means includes a modulating body, the modulating body having an outer wall and a passageway defined therethrough, the modulating body being pivotable about the pivot axis; and
the outer wall of the modulating body and the passageway are shaped such that:
a) when the modulating means is in the first mode,
the passageway fluidly connects the first outlet to the first inlet, and
the outer wall of the modulating body blocks the second outlet and the second inlet such that there is one of: no flow, and marginal flow of fluid through the second outlet and the second inlet;
b) when the modulating means is in the second mode,
the passageway fluidly connects the second outlet to the second inlet, and
the outer wall of the modulating body blocks the first outlet and the first inlet such that there is one of: no flow, and marginal flow of fluid through the first outlet and the first inlet;
c) when the modulating means is in the third mode,
the passageway fluidly connects the first outlet and the second outlet to the second inlet, and
the outer wall of the modulating body blocks the first inlet such that there is one of: no flow, and marginal flow of fluid through the first inlet; and
d) when the modulating means is in the fourth mode, the outer wall of the modulating body blocks the first inlet and the second inlet such that there is one of: no flow, and marginal flow of fluid through the first inlet and the second inlet.

25. The flow control valve of claim 24, wherein:
the first outlet is fluidly connected to the cavity via a first opening defined in the peripheral wall of the cavity;
the second inlet is fluidly connected to the cavity via a second opening defined in the peripheral wall of the cavity, the second opening being different from the first opening;
the passageway has a first open end defined in the outer wall of the modulating body and a second open end defined in the outer wall of the modulating body, the second open end being fluidly connected to the first open end; and
the outer wall of the modulating body and the passageway are shaped such that when the modulating means is in the fifth mode,
i) the first opening is fully open to the first open end of the passageway,
ii) the second opening is fully open to the second open end of the passageway, and
iii) the outer wall of the modulating body blocks the first inlet and the second outlet.

26.-32. (canceled)
